(19) United States
(12) Patent Application Publication
(10) Pub. No.: US 2016/0019195 A1
(43) Pub. Date: Jan. 21, 2016

(54) METHOD AND SYSTEM FOR POSTING COMMENTS ON HOSTED WEB PAGES

(71) Applicants: Jesse Kelly SULTANIK, Tel Aviv (IL); Nir NAOR, Herzlia (IL); Nitzan GELBARD, Beit-Herut (IL)

(72) Inventors: Jesse Kelly SULTANIK, Tel Aviv (IL); Nir NAOR, Herzlia (IL); Nitzan GELBARD, Beit-Herut (IL)

(21) Appl. No.: 14/714,496

(22) Filed: May 18, 2015

Related U.S. Application Data
(60) Provisional application No. 62/000,648, filed on May 20, 2014.

(51) Int. Cl. G06F 17/24; G06F 17/22

(52) U.S. Cl. CPC G06F 17/241; G06F 17/2247

(57) ABSTRACT

Methods and systems that allow users to post comments on hosted web pages and web sites. The users post their comments, inputted over a network, on an overlying electronic document, also known as a web document, at positions in the electronic document corresponding to a user-selected location of the underlying web page.

### CROSS-REFERENCES TO RELATED APPLICATIONS

This patent application is related to and claims priority from commonly owned U.S. Provisional Patent Application Ser. No. 62/000,648, entitled Method and System for Posting Comments on Hosted Web Pages, filed on May 20, 2014, the disclosure of which is incorporated by reference in its entirety herein.

### TECHNICAL FIELD

The present invention relates to methods and systems for administering comments made by users at web sites and web pages.

### BACKGROUND

Numerous web sites and web pages provide designated areas on the web site or web page where users, who have directed their browsing application to these web sites or web pages, can post comments. These comments remain on the pages and are viewable by other users, who have directed their browsing application to these web sites or web pages.

The comments are completely administered and controlled by the operator of the web site or web page. As a result of this administration and control, comments are limited to comment areas, in an order established by the web page or web site's operator. These comments may be taken off the web site or web page at any time, and in some cases, the comments may never be posted in the comment areas of the web sites or web pages, due to censorship by the operator of the web site or web page.

### SUMMARY OF THE DISCLOSED SUBJECT MATTER

The present invention includes embodiments that are directed to methods and systems that allow users to post displayable media, for example, in forms such as comments, and access information, relating to web pages, and also web sites, in a layer of new media, independent of (e.g., separable from) the web pages and web sites themselves. Users can post or input their displayable media, e.g., comments, in the layer of new media at a desired position or location in the new media layer. The displayable media, e.g., the comments, relates to the content on the underlying web page. Embodiments of the present invention also relate to methods and systems for administering comments, and generating and/or obtaining content related to the comments, which have been inputted into the system.

The present invention includes embodiments that allow for the implementation of a new layer of media, which overlies web pages and/or web sites, for facilitating the posting of displayable media, including comments on almost every web page and web site on the World Wide Web (WWW). This holds true regardless of the entity hosting, controlling or administering the web page or web site, and, regardless of the web page or web site having its own owner-designated comment area.

The present invention also includes embodiments that allow the users to make comments at their desired locations of the web page or web site, such that users are no longer limited to website/web page owner designated comment areas in the web page/web site, Accordingly, with embodiments of the present invention, user comments may appear above the fold on the web page, in contrast to presently available owner-designated comment areas, which are typically below the fold and at the end of a content piece, e.g., article, which is below the fold. Embodiments of the present invention also allow users to customize the types of comments and/or information able to be accessed in the new layer of media of the present invention.

Some embodiments of the present invention are directed to methods and systems that allow users to post comments on hosted web pages and web sites. The users post their comments, inputted over a network, on an overlying electronic document, also known as a web document, at positions (locations) on the electronic document corresponding to a user-selected location of the underlying web page.

Some embodiments of the present invention are directed to a system and method for the generation and administration of web documents or electronic documents, collectively known as “web documents,” with “web documents” and “electronic documents” used interchangeably herein. These web documents are programmed to overlie a web page or web site, or portions thereof, and on these overlying web documents, users can post (make or input) and place (position or locate) comments at locations on the overlying web document that correspond exactly or proximate to the specific locations of the content, for example, paragraphs, phrases, graphics, and the like, on the underlying web page. The user-selected locations for the comments are for viewing of the posted and located comments by future users who visit the web page or web site, by directing their browsing application to the aforementioned web page or web site. The users can also interact with existing comments. As described herein, “comments” are text, graphics, audio and video clips and the like, input by users to the web documents, at desired locations thereon, corresponding, for example, to the content at the same location on the underlying web page, for example, over a network such as the Internet. The web document or electronic document, which makes the posting of and interaction with comments and links to media possible, is generated and administered by the system of some embodiments of the present invention.

The web documents are added functionality to a web page, or servers, which host the web page/web site. The web documents are integrated on a web site or web page, through embeddable code or widgets, that when the necessary files are obtained by the web site host, for the desired web page or web site, the code or widget is embedded into the code of the web sites and web pages. The web site host is, for example, an entity different from the users, who direct their browsing applications to the web site or web page of the web site host, in order to view the content and subsequently place comments on the web document which overlies the web site or web page of the web site host. When these web sites or web pages are presented to users, the users may post comments and access relevant information via these web documents at locations corresponding to one or more specific location of the web page underlying the web document. For example, the specific one or more locations may be content of interest, such as a paragraph or other text passage, picture, advertisement, phrase, tab, banner or the like on the underlying actual web page or web site. When the locations, selected by the users, are analyzed over many web pages, information can be produced, which is relevant to understand various trends and language development, as well as other traits of users and society.

This posting of comments at specific locations on the web page may be indicative of topics of current interests, trends, and the like. This posting of comments at specific location on the web page or web site allows for comments at numerous locations of web pages or web sites, such as within articles, proximate to photographs, as opposed to the presently available designated comment area at the bottom of the web page or web site following the end of the article, advertisement or information.

The users, who access the web page or web site, to post comments on the web document associated therewith, do not need any special hardware, software, or other applications for their computers in order to post comments on these web pages of the web site host, provided that the code associated with the embodiments of the present invention is embedded and running on those web pages (with the web document overlying portions or all of the hosted web page). However, it is desired that users should register with the system to post comments on the aforementioned web documents, but may do so as a guest, in an unregistered state, also in accordance with some embodiments of the present invention.

Some embodiments of the present invention are also directed to an application for providing users whose browsing applications are directed to a web page, the ability to input and access displayable media, including text, graphics, and the like, and transmit this displayable media over a network, such as the Internet, to a web document or electronic document, which overlies a web site or web page hosted by a different entity. The displayable media is then posted on this web document or electronic document, for example, as a comment.

Some embodiments of the present invention are directed to systems and methods which match content to a user's interests at a particular point in time.

Some embodiments of the present invention allow web page/web site hosts of web documents to address the latent demands of the client through real-time analysis of the interactions taking place about a targeted piece of content (e.g., a paragraph). Since users can express themselves “in the moment” and in relation to something specific, embodiments of the disclosed methods and systems enable the provisioning of content that precisely addresses the user's interest at a particular point in time.

Embodiments of the present invention are such that the disclosed systems capture precise emotional responses of users towards specific content. This ability, to match the reaction and interaction of users with specific content, allows webmasters of websites and/or web pages to understand what content, which they produce, is the most intriguing to users. Additionally, the system's matching of the aforementioned reaction and emotional responses provides insight to webmasters of the webpage/web sit in regards to where a user wants to direct his attention next.

Embodiments of the present invention function to aggregate information associated with comments, specific content within webpages and articles, and the entities a user interacts with. Embodiments of the disclosed system may also be programmed to facilitate group commenting or private commenting viewable only to specific users that may associate groups of users with privately created interaction sessions. These groups and private commenting sessions could link users associated with these groups to other similar web sites, web pages or conversations.

Embodiments of the present invention are also such that the disclosed system can be programmed to aggregate and map comments in order to understand various traits of comments and commenters, popular content, trending topics, controversial content or actors and other types of data in relation to users and content. Additionally, the disclosed system can be programmed to recall each comment made, such that natural language development, memes, mass opinions, democratic participation and phrase coinage can be tracked. These comment strings can also be broken down further so as to allow for cross referencing with metadata which can be used to generate content links, to connect like-minded commenters with targeted content, and or to make forecasts regarding the quality of comments on past, current and/or future web documents associated with the system

The aforementioned features of embodiments of the disclosed systems and methods allow for the providing of insight into the emotional affect of specific content on users. Further, by aggregating the responses of users over many instances of system use, the disclosed system provides comprehensive user profiles at high levels of detail.

Some embodiments are directed to a method for placing, for example, posting, displayable media on web pages. The method comprises: providing an electronic document (also known as a web document) for placement over at least a portion of a hosted web page; receiving displayable media input over a network from the first user whose browsing application is directed to the web page; and, placing the displayable media input by the first user into the electronic document.

Optionally, the placing the displayable media includes placing the displayable media at a position (location) in the electronic document corresponding to a user selected location on the underlying web page.

Optionally, the displayable media includes text defining a comment.

Optionally, the displayable media includes at least one of graphics, images, audio, video, defining a comment.

Optionally, the method additionally comprises: providing content to the electronic document.

Optionally, the providing content includes providing content based on analyzing the displayable media of the electronic document.

Optionally, the providing content is additionally based on analyzing at least one of content from the web page, information about the history of the browsing application associated with a computer of the user, information about the user, and, input received from the user.

Optionally, the content includes at least one of activatable links to target web sites.

Optionally, the content includes information.

Optionally, the information includes advertising information.

Optionally, the providing an electronic document for placement over at least a portion of a hosted web page includes providing the electronic document for placement over at least a substantial portion of the hosted web page.

Optionally, the network includes the Internet.

Embodiments of the present invention are directed to a system for placing, for example, posting, displayable media on web pages. The system comprises a processor and storage media. The storage media is in communication, for example, data communication and/or electronic communication, with the processor. The storage media stores instructions executable by the processor. The instructions comprise: providing an electronic document (also known as a web document) for positioning over at least a portion of a hosted web page; receiving displayable media input over a network from the first user whose browsing application is directed to the web page; and, placing the displayable media input by the first user into the electronic document.

Optionally, the instructions additionally comprise: placing the displayable media at a position (location) in the electronic document corresponding to a user selected location on the underlying web page.

Optionally, the instructions additionally comprise: providing content to the electronic document.

Optionally, the providing content instructions include instructions for providing content based on analyzing the displayable media of the electronic document.

Optionally, the providing content instructions additionally include instructions for providing content based on analyzing at least one of content from the web page, information about the history of the browsing application associated with a computer of the first user, information about the user, and, input received from the first user.

Embodiments of the present invention are directed to a computer usable non-transitory storage medium having a computer program embodied thereon for causing a suitably programmed system to place displayable media on web pages, the web pages accessible via a network, by performing the following steps when such program is executed on the system. The steps comprise: providing an electronic document (also known as a web document) for placement over at least a portion of a hosted web page; receiving displayable media input over the network from the first user whose browsing application is directed to the web page; and, placing the displayable media input by the first user into the electronic document.

Optionally, the step of placing the displayable media includes placing the displayable media at a position (location) in the electronic document corresponding to a user selected location on the underlying web page.

Optionally, the displayable media includes text defining a comment.

Optionally, the displayable media includes at least one of graphics, images, audio, video, defining a comment.

Optionally, there is an additional step of: providing content to the electronic document.

Optionally, the step of providing content includes providing content based on analyzing the displayable media of the electronic document.

Optionally, the step of providing content is additionally based on analyzing at least one of content from the web page, information about the history of the browsing application associated with a computer of the user, information about the user, and, input received from the user.

Optionally, the content includes at least one of activatable links to target web sites.

Optionally, the content includes information.

Optionally, the information includes advertising information.

Optionally, the step of providing an electronic document for placement over at least a portion of a hosted web page includes providing the electronic document for placement over at least a substantial portion of the hosted web page.

Optionally, the network includes the Internet.

This document references terms that are used consistently or interchangeably herein.

These terms, including variations thereof, are as follows.

The term “click”, “clicks”, “click on”, “clicks on” involves the activation of a computer pointing apparatus, such as a device commonly known as a mouse, or a touch, swipe, or the like on a touch screen, on a location on a computer screen display, including screen displays of tablets and mobile telephones. The screen displays are activatable, for example, by an activatable icon, that causes an action of the various software and or hardware, including that for executing applications and supporting the computer screen display.

In a standard computer pointing device, known as a mouse, the apparatus has a left button, which is typically the primary or default button, and a right button, through which activations can be made by pressing the requisite button. Pressing the left button results in a “left click,” while pressing the right button results in a “right click” on the right mechanism. A “left click” includes any “click”, “clicks”, “clicks on”, “click on” that results in a primary action taken by the software and or hardware components of the user computer. A “right click” includes any “click”, “clicks”, “click on”, “clicks on” that results in a secondary action, such as adding or modifying the action options that the user can cause the software and or hardware components of the computer to take. These settings on the pointing device are typically the default settings, but may be switched, depending on the user. In this document, the default settings are used and described.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible over Networks including the Internet.

“n” and “n^{th}” in the description below and the drawing figures represents the last member of a series or sequence of members, such as elements, servers, databases, caches, components, listings, links, data files, etc.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, PDA, or cell phone).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

A “client” is an application that runs on a computer, workstation or the like and relies on a server to perform some of its operations or functionality.

A “comment” includes expressions, statements, sentences, sentence fragments, symbols, and any combinations thereof, in any language, presented as text, graphics, links, audio, video, and any other form of electronic media, or other displayable media, including any combinations thereof.

A “comment box” is a type of form, or electronic document, which is used by users of the system to access previously made comments as well as information regarding, or relating to, the element, or area, of a web page which it overlies. Comment boxes are also used by users of the system of the present invention to input displayable media in the form of, for example, comments. The accessing of comment boxes, by the users of the system, is used by the system to track in aggregate form various types of qualities of users, web pages and the Internet.

A “new comment icon” is an activatable icon that can appear next to specific content within webpages and which users can click on in order to activate. Clicking on a new comment icon will generate a comment box that does not hold any previously made comments but that can display information relevant to the user, the page on which he is found and other information deemed by the system to be relevant to that user at that moment.

An “existing comment icon” is an activatable icon that will appear in a fixed location on a webpage. The appearance of the existing comment icon notifies the viewers of that web page that at least one previous visitor to the web page has made a comment referring to the element on the underlying web page next to which the icon appears. Clicking on an existing comment icon will generate a comment box that contains the previously made comment(s) and other information. The comment box generated after a click on an existing comment icon can display information relevant to the user, the element to which the comment icon refers, the page on which the user is found as well as other information deemed by the system to be relevant to that user at that moment.

A “BUBBLE” is a term used to reference existing comment icons and acts as the ID call name for existing comment icons in the database.

HTML (Hypertext Markup Language) is the set of markup symbols or codes inserted in a file intended for display on a World Wide Web browser page.

HTTP (Hypertext Transfer Protocol) is an application protocol for distributed, collaborative, hypermedia information systems. Hypertext is structured text that uses logical links (hyperlinks) between nodes containing text. HTTP is the protocol to exchange or transfer hypertext.

A GET request is an HTTP command used to request a file, or series of files, from a Web server. GET requests are, for example, implemented in HTML files (Web pages) for making database queries that do not involve any updating at the server side. In this document, GET requests are generic to all types of GET requests, while BUBBLE GET requests, COMMENT BOX GET requests, SENTIMENT GET requests, and RELEVANCE GET requests are specific types of GET requests and are indicated as such.

A POST request is an HTTP command that typically makes a request that a web server accept the data enclosed in the request message's body for storage. POST requests are used, for example, when uploading a file or submitting a completed web form. In this document, POST requests are generic to all types of POST requests, while INTERACTION POST requests, USER POST requests, COMMENT POST requests, BUBBLE POST requests CONTENT POST requests, and PAGE POST requests are specific types of POST requests and are indicated as such.

An AJAX (Asynchronous JavaScript and XML) Request is an HTTP request made by (browser-resident) JavaScript that uses XML (Extensible Markup Language) to encode the request data and/or response data.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A is a diagram of an exemplary environment for the system in which embodiments of the disclosed subject matter are performed;

FIG. 1B is a diagram of a screen shot with an exploded view of a web document, which is generated by the system in accordance with the disclosed subject matter, overlying a web page, illustrating embodiments of the disclosed subject matter;

FIG. 2 is a diagram of the database and subdatabases of a system in accordance with embodiments of the disclosed subject matter;

FIGS. 3A-3G are diagrams of the subdatabases of FIG. 2;

FIGS. 4-19 are flow diagrams of processes in accordance with embodiments of the disclosed subject matter; and,

FIGS. 20-29 are screen shots or screen diagrams that appear on the monitor of the computer of the user in accordance with embodiments of the disclosed subject matter, during the processes represented by FIGS. 4-19.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

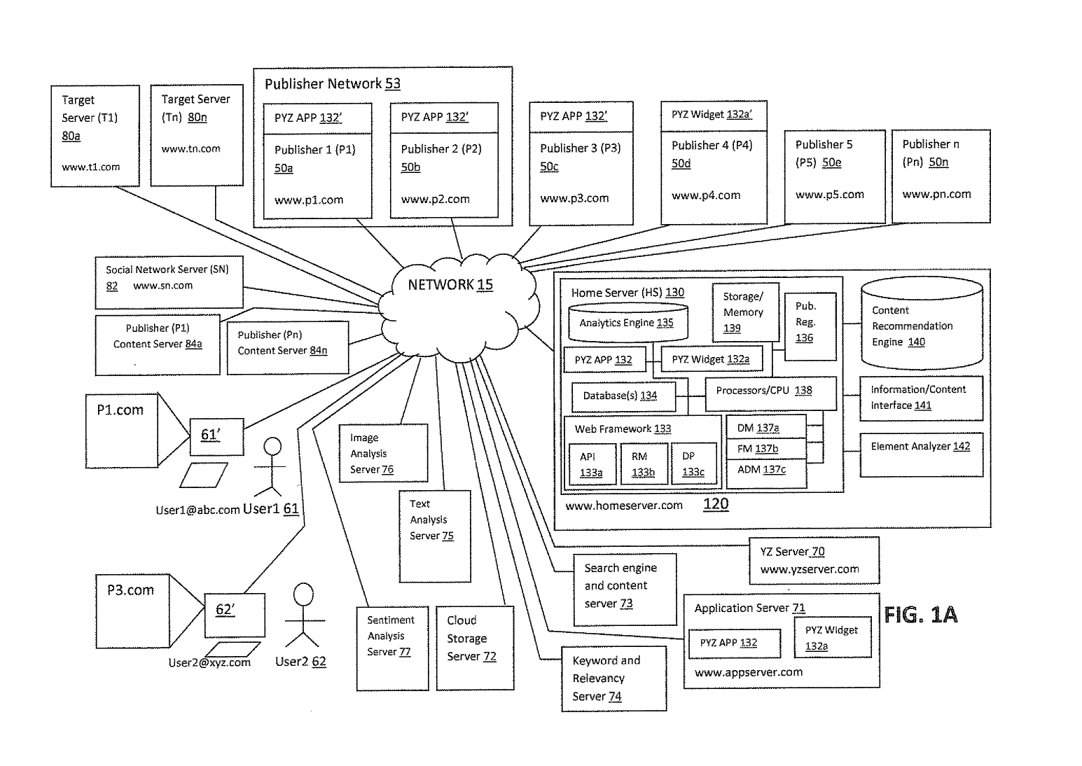

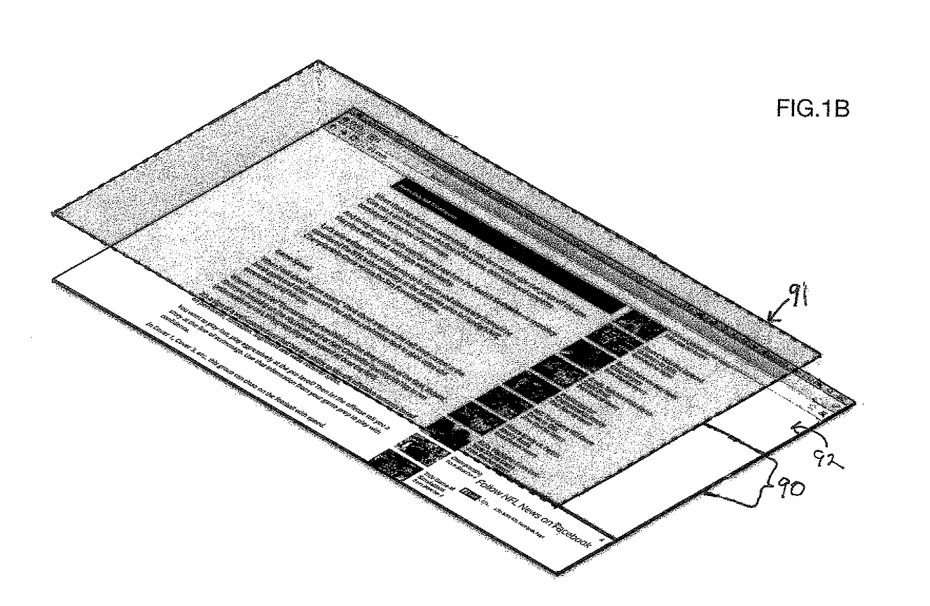

Reference is now made to FIG. 1A, which shows an exemplary operating environment, including a network 15, to which is linked a non-limiting exemplary system 120, in accordance with some embodiments of the present invention. The system 120 is formed of various servers and server components, computers, computer devices and the like, storage media, processors, and the like. The system 120 includes a home server (HS) 130, also known as a main server, which is linked to the network, either directly or indirectly, and a client application 132. Throughout this document, an “application refers to executable software, and optionally to the electronic documents and web documents (both terms as defined herein), and any graphical user interfaces (GUI), through which certain functionality may be implemented. Throughout this document, references to the system 120 include operations performed by either the home server 130 itself, or the system 120, including the home server 130, along with any computers, servers, other components, and applications, e.g., client applications, associated with either the home server 130 or the system 120. Additionally, references to “the system” are to the system 120, including the home server 130, and any components and applications associated therewith, as detailed immediately above. The network 15 is, for example, a communications network, such as a Local Area Network (LAN), or a Wide Area Network (WAN), including public networks such as the Internet. As shown in FIG. 1A, the network 15 is, for example, the Internet.

The aforementioned environment also includes publisher servers 50a-50n of publishers P1-Pn, representative of all publishers linked to the network 15. Publisher servers 50a-50n, for example, publisher servers 50a and 50b, of publishers P1 and P2 are formed into a network, represented by box 53. By being networked, the content from these publisher servers 50a, 50b is jointly accessible from both of these servers 50a, 50b, even though only one server of these servers 50a, 50b is in direct communication with a user computer. Publisher servers 50c, 50d, 50e, through 50n are independent of the publisher network 53.

There are users User1 61, User2 62, representative of all users having access to the network 15, with their corresponding computers 61′, 62′ linked directly or indirectly to the network 15. These computers 61′, 62′ are representative of multiple user computers (of multiple users) linked to the network 15 and accessing the system 120, including the home server 130. The user computers 61′, 62′ are, for example, personal computers with, for examples, Windows® or Mac® operating systems and processors such as Intel Pentium® processors, and the like, capable of running multiple applications, and may also include tablet (e.g., iPad® from Apple of Cupertino, Calif.) and laptop computers, as well as mobile devices, such as smart phones (e.g., iPhone® from Apple of Cupertino, Calif.), iPods®, terminals, workstations, and the like. The computers 61′, 62′ are equipped with browsing applications, browsers or web browsers, these terms used interchangeably herein, such as Internet Explorer® from Microsoft, or Chrome® from Google. These computers 61′, 62′ include monitors or display screens on which the user can view different types of media.

There are servers in the environment, such as a server 70, which, for example, hosts a website that aggregates data in relation to the web pages and the comments associated therewith, viewable by users. There is also an application server 71, on which the downloadable and embeddable application 132 (PYZ APP 132) or downloadable and embeddable widget 132a (PYZ widget) can also be hosted, prior to downloading and embedding by the publishers (and other third parties) into their web sites and web pages, which they host. There is also a storage server 72, for storing data, such as text and images in the “cloud,” search engine and content server 73, and, a keyword and relevancy server 74, which serves as a keyword and relevancy engine. There is also a text analysis server 75, and image analysis server 76, and a sentiment analysis server 77. One or more of these servers 70-77, in any combination, or all of the servers 70-77 may be part of the system 120.

The application server 71, remotely supports the client applications, e.g., the PYZ APP 132 and PYZ widget 132a, which may be downloaded (and embedded or integrated into the code of the web page and/or web site, hosted, for example, by a publisher server P1-Pn 50a-50n) from this server 71. This server 71, for example, has the URL, www.appserver.com.

Cloud Storage server 72, functions to store generic images and/or media associated with content listings, for example, of information, including advertisements, which may not have associated image or graphic assets.

The search engine and content server 73, serves to match user profiles and preferences, defined and updated in real time in accordance with user actions, with content. These matches are made in accordance with instructions set by the system administrator, e.g., relevance, yield, and other parameters. For example, a server, here, for example, a publisher server P5 50e, which has not embedded the application 132 or the widget 132a, could have content uploaded to the system 120 via the search engine and content server 73 (or through the information/content interface 141, described herein).

The keyword and relevancy server 74 functions to assign a score, for example, a percentage or other representative value, to a keyword, identified by the system 120 to exist, for example, on the target web page or in a comment, that represents, for example, the relation of the natural language term to the content that exists on the URL. The text analysis server 75 functions to identify natural language terms, for example, for a URL being analyzed. The image analysis server 76 functions to assign keywords, terms, and the like to images.

The sentiment analysis server 77, serves to assign a sentiment score, that reflects, for example, an adjective tone, such as positive or negative, of a given piece of content, a comment, or a web page.

Additionally, servers 74, 75, 76, 77 have data parsing capabilities, as they include data parsers. The data parsing capabilities may also be performed by the data parser (DP) 133c.

The environment also includes additional servers such as third party servers (TPS), including, for example, target servers 80a through 80n, linked to the network 15, which, for example, host various web sites and web pages. The environment also includes a social network server (SN) 82, linked to the network 15, representative of social networks and their respective servers, such as Facebook® (www.facebook.com), MySpace® (www.myspace.com), and the like. There are typically also publisher content servers 84a through 84n.

Target servers 80a through 80n represent numerous target content servers. These servers 80a through 80n are linked to the network 15, and are reached from a user's browser redirection, when the user clicks on, or otherwise activates, a link to these servers 80a, 80n. These target servers 80a, 80n are typically associated with a content provider, such as an information provider or advertiser. These target servers 80a, 80n, have the respective URLs, www.t1.com and www.tn.com, and are destinations for browser redirections, in accordance with the embodiments of the present invention detailed herein. In a typical environment, the target servers 80a, 80n are independent of, and not related to or controlled by, the parties associated with the publishers (represented by publisher servers P1-Pn 50a-50n) the social network server 82, the system 120, or servers 70-77.

For example, when content is provided to a user, as detailed herein, the content is, for example, associated or hosted by a server, for example, represented by the target servers 80a-80n. When the user activates a link, or other object, button or the like, associated with the provided content, the browsing application associated with the user's computer redirects to the web site or web page hosted by the target server 80a-80n. For example, if the user receives content for Fred's Auto Repair, with the URL Fredsautorepair.com, whose web site is hosted by target server 80a, once the content is activated, the user, via his computer browsing application, is redirected to the URL of fredsautorepair.com, hosted by the target server 80a.

The social network (SN) server 82, is exemplary of social network servers, such as those of Facebook®, MySpace®, and has the URL of www.sn.com. This social network server (SN) 82 operates with the system 120, to transfer data associated with users', e.g., user1 61, user2 62, of the integrated or embedded application 132, e.g., the PYZ APP 132′, or widget 132a, e.g., the PYZ widget 132a′, as detailed further below.

The content provider servers 84a through 84n include one or more servers for providing content, such as information, including advertising to a publisher. For example, for publisher 1 (P1), the content provider server 84a can be accessed directly when providing content to a web page associated with Publisher 1 (P1) and Publisher 2 (P2), as this publisher is in the network 53 with Publisher 1 (P1). This content provider server 84a is exemplary of content provider servers which may be used by any and all publishers P1-Pn, and other servers.

All of the aforementioned servers 50a-50n, 70-77, 80a-80n, 82 and 84a-84n, and 130, along with user computers 61′, 62′ (via their associated servers, which are not shown) are linked to the network 15, either directly or indirectly, as well as to an endless number of other servers and the like, via the network 15. The aforementioned servers are linked to the network 15, so as to be in electronic communication, both directly and indirectly with each other and any other servers and/or computers, computer systems and the like, including the user computers 61′, 62′, via the network 15. While single servers are shown, each of the aforementioned servers may be represented by multiple servers, computers, components and the like.

The system 120 includes the home server (HS) 130, as discussed above. The system 120, for example, via the home server 130, includes hardware and software, and combinations thereof, for administering and maintaining web documents or electronic documents (collectively known as “web documents”), and all functions associated therewith, for example, to provide commenting functionality and content providing as detailed herein. Throughout this document the terms “web documents” and “electronic documents” are used interchangeably herein. These web documents support comments posted by users, as well as separate commenting threads, received over the network 15, and optional content, such as information including advertising and link recommendations, which may be targeted to the user who has interacted with the system 120 by, for example, posting a comment on a web document, and is viewing one of the aforementioned web documents.

The web documents are, for example, hosted by publishers P1-Pn on their servers 50a-50n, to overly web pages and web sites, or portions thereof, once the respective publisher P1-Pn, has downloaded an application 132 (also known as the PYZ Application), or widget 132a (also known as the PYZ Widget), both of which can, for example, automatically embed when instructed or programmed to do so, by a web administrator, in the code for the webpages/web sites hosted by the respective publisher servers. The aforementioned programming can make the embedding automatic.

The PYZ APP 132 and PYZ Widget 132a, when embedded or integrated into the code of the hosted web pages/web sites, such as those of the publisher servers P1-Pn 50a-50n (and once embedded or integrated are referenced as PYZ APP 132′ and PYZ Widget 132a′), are, for example, client applications, that for example, are part of the system 120. The widget 132a differs from the application 132 in that the widget 132 does not support the aforementioned electronic documents or web documents. Rather, the widget 132a has a different functionality than the application 132, in that the widget 132a allows publishers 50a-50n or other web site/web page hosts to automatically upload content, for information and content providing, such as advertising, to the system 120. Ultimately, users can input displayable media, e.g., comments, that may relate to the uploaded content causing links to the aforementioned content to be displayed to the user which they may subsequently activate in order to direct their browser to the target server 80a-80n, which hosts this content.

Turning also to FIG. 1B, which shows a screen display 90, as it appears on a computer monitor, with a web document 91 overlying a web page 92. However, the web document 90 may also overlie a portion of the web page. The web page 92 is, for example, hosted, for example, by a publisher server, for example, publisher server 50a of Publisher 1 (P1).

The home server (HS) 130 is of an architecture that includes one or more components, engines, modules and the like, for providing numerous additional server functions and operations, and, for running the processes associated with the application 132 upon its being downloaded by a publisher server 50a-50n, or other web page or web site hosting server. The home server 130 also includes a web framework 133 and a database 134, also known as a main data base. The database 134 may be one or more databases and also include multiple databases, subdatabases, caches, tables and the like. The home server (HS) 130 may be associated with additional storage, memory, caches and databases, both internal and external thereto. For explanation purposes, the home server (HS) 130 may have a uniform resource locator (URL) of, for example, www.homeserver.com. While a single home server (HS) 130 is shown, the home server (HS) 130 may be formed of multiple servers and/or components.

The application 132 includes the necessary code to operate these web documents, for example, on remote publisher server P1-Pn 50a-50n. The application 132, which supports and administers these web documents, and is stored, for example, in the home server 130 or other supporting server(s), such as application server 71, for distribution, via downloads, and embedding or integrating into code of the requisite web page/web site. This embedding or integrating may be, for example, automatic or manual, at the request of the system administrator. The application 132 when embedded or integrated into the code of the web pages/web sites can provide a temporary storage function.

The application 132 may also be provided to the publisher server 50a-50n by conventional media, and the web master of the publisher server 50a-50n embeds or integrates the application into the code of the web site or web page either manually or automatically. The same holds true for the widget 132a Users, and others, including other machines, linked to the network 15, for example, users 61, 62, representative of multitudes of users linked to the network 15, can post comments, and optionally receive content, such as information content including advertising, in or proximate to comment boxes generated by the application 132′ on the web documents. These web documents are active on the publisher web page or web site, and typically being viewed by the user via his computer, as the web page or web site has been rendered to the browsing application of the computer.

Upon downloading the PYZ APP 132, the administrator of the publisher server 50a-50n, directly integrates or embeds the code of the application 132, i.e., the PYZ APP 132, into the code of the publisher's P1-Pn web page or web site, on the corresponding publisher server 50a-50n. This integration or embedding may also be done automatically should the publisher server P1-Pn be programmed accordingly. The embedded or integrated PYZ APP 132′ maps to the system 120, typically, the home server 130. The PYZ APP 132′ enables the web master, administrator, or the like, to define the subjects for the comments, define the types of elements, which may also include locations, within the publisher hosted web pages that comment boxes may be generated around. The comments and content provided are, for example, in the form of text, graphics and the like, and received by the web documents, over the network 15, such as the Internet. Additionally, the web document may be personalized or customized according to the user that has requested the presentation of the web page or web site. The aforementioned web documents are generated and administered by the requisite Publisher P1-Pn, via their associated publisher server 50a-50n, whereby the publisher maintains at least partial control over the web document, which overlies the hosted web page or web site.

The application 132, following embedding or integrating by a publisher P1-Pn, at the respective publisher server, (the downloaded application 132 at the publisher server represented by element 132′), maps to the system 120, including the home server 130. The PYZ APP 132′ also includes, for example, a CSS (Cascading Style Sheet) Selector function, which allows the end user, represented by user1 61 and user2 62, to distinguish between the different HTML elements found within the body of a web page, to which comments and content associated with the system 120, refer. The webmaster or administrator of the publisher server, which hosts the web page and the embedded web document, may also use the CSS Selector function to define the subjects for the comments, types of elements, which may also include locations, within the publisher hosted web pages that comment boxes may be generated around.

In this document, an “interactive web document” is a web page with the PYZ APP 132′ integrated in its' code and running in the host server, e.g., a publisher server P1-Pn 50a-50n, in real-time. Also, in this document, a “web input, interactive and portal document” is a web page with the PYZ APP 132 integrated in its' code, running typically in real time, and which is additionally supporting an open comment box on the display monitor of the user.

When downloaded by a publisher, for example, at that publisher's server, for example, publisher server P4 50d, where the widget 132a is hosted, the now downloaded and subsequently integrated or embedded widget 132a is represented as 132a′. The widget 132a′ maps to the system 120, for example, to the home server 130. The PYZ APP 132′ and PYZ widget 132a′ depend on various resources, as well as rules and policies of the system 120, including the home server 130, to perform some of their operations. The home server 130 monitors and maintains the data and any other electronic communication or linkage with the PYZ APP 132′ and/or the PYZ Widget 132a′, embedded and running on the respective publisher servers, e.g., P1-P4, 50a-50d.

Both the PYZ APP 132′ and the PYZ widget 132a′ also function to upload and transfer content to the system 120, for one or more analyses by one or more of the servers 74-77, for example, for keywords and relevancy 74, text analysis 75, image analysis 76, and sentiment analysis 77. This uploaded content, as analyzed by one or more of the servers 74-77, may be used as content, e.g., information such as advertising, to be provided to users, e.g., users 61, 62.

The publisher servers 50a-50n are, or can be, suitably programmed for supporting the number 132′ as it has been downloaded, and typically integrated or embedded in or on the code of the publisher server 50a-50n). For example, the code of the PYZ APP 132, once downloaded by the respective publisher server, for example, publisher servers 50a, 50b of Publisher P1 and P2, is integrated or embedded into the code of the web page or web site, or portions thereof, of the respective publisher server 50a (Publisher P1), 50b (Publisher P2).

The application 132 is hosted on the respective publisher server, for example, publisher servers 50a, 50b of a network 53 of publishers P1 and P2, and a publisher server 50c of publisher P3, which is not part of the network 53. Publisher server 50d, of Publisher P4, which is also not part of the network 53, has embedded or integrated the PYZ widget 132a′.

User1 61 and user2 62, can make and view one or more comments through one or more comment boxes (detailed herein below) at user-selected locations inside the preset layout of the content of publisher (P1-Pn) web page(s), which the comment boxes, and their corresponding comment icons, overlie and refer to. As shown in FIG. 1A, for example, the application (PYZ APP) 132′ is hosted on the publisher servers P1 (with the URL www.p1.com) 50a, P2 (with the URL www.p2.com) 50b, P3 (with the URL www.p3.com) 50c, and the widget (PYZ widget) 132a′ is hosted on the publisher server P4 (with the URL www.p4.com) 50d. Users, represented by user1 61 and user2 62, need only access the web site or web page of the publisher P1, P2, P3, hosted by the corresponding publisher server 50a, 50b, 50c, to place comments at the desired locations on the web site or web page. The widget 132a′ allows content to be uploaded to a web document, via a comment box, on a web page, which the system 120 determined to be of interest to the user, for example, in the form of advertising.

The computers 61′, 62′ of the users 61, 62 do not need any special software, hardware or other modifications in order to interact with the aforementioned publisher web sites and web pages, other than an Internet browsing application, e.g., to place comments and receive content on these web sites or web pages, in the comment boxes, in relation to locations on the underlying web pages to which the users have posted their comments.

The comments are typically associated with the content of the web page of any publisher P1-Pn 50a-50n, which the web document overlies (the web document supported by the system 120). The comments, stored in comment icons and their corresponding comment boxes, are located based on the location of where the user-selected content appears on the underlying web page. The application 132′ allows for the transmission, storage, and analysis, of these comments in the system 120 and the home server 130, for example, over the network 15.

The widget 132a′ differs from the application 132′ as it is limited to allowing the publisher to upload content, for example, automatically. The home server 130 receives and stores these comments, and displays these comments as a web document overlying the publisher P1-Pn 50a-50n web page or third party web page. The publisher may have some control over the electronic document that overlies their web page, on which comments and content are placed. The comments are stored on the home server 130, and can be retrieved, for example, automatically, when other users, who have directed their browsers to the publisher's web site or web page, wish to view the comments or place new comments at a desired location on the publisher web site or web page. This process is provided in greater detail below.

The system 120 interacts with, and supports the client, the PYZ APP 132′ (for example, running on a publisher server, such as publisher servers 50a, 50b, 50c, as shown in FIG. 1A. The home server 130 includes, for example, modules/components for supporting resources retrieved from the system via the web framework 133 (also known herein as the web framework component). This web framework 133 communicates directly with the PYZ APP 132′, in order to receive, retrieve and transfer data to the PYZ APP 132′ from other components of the home server 130 and/or the system 120, such as the database 134.

The web framework 133 is the component of the home server 130 responsible for communicating with each embedded PYZ APP 132′ and/or widget 132a′. This web framework 133 is also for retrieving data in relation to received GET request(s) from the PYZ APP 132′ and/or widget 132a′, and storing data in relation to received POST requests. The GET requests, for example, a BUBBLE GET request, once received, cause the web framework 133 to, for example, automatically search the database 134 of the home server 130 for the data requested by the PYZ APP 132′ in the GET request.

In response to AJAX HTTP GET requests, the web framework 133 returns an AJAX HTTP message to the PYZ APP 132′. The AJAX HTTP message, which, when containing data, about existing comment icons on the page from which the BUBBLE GET request was sent. This AJAX HTTP message also causes the PYZ APP 132′ to display comment icons, and can also cause the display of other activatable icons and content, on the monitor (of the computer) of the user. The web framework 133 is able to send and receive data via a direct data transfer link to the database 134 of the home server 130 and to each PYZ APP 132′. While action on a single GET request has been detailed above, this is exemplary of the handling of all GET requests by the system 120, including the home server 130. The system 120 can process one or more GET requests, either simultaneously, contemporaneously or at different times.

The system 120 also processes POST requests. Once received by the system 120, the POST request causes the web framework 133 to transfer and store the data included in the POST request in the relevant tables of the database.

The web framework component 133 is, for example, a software framework, which supports, websites, web applications, such as the PYZ APP 132, web services and web resources. The web framework component 133 is programmed to either sort, retrieve and or return relevant data in accordance with each AJAX HTTP GET and each POST request received from the PYZ APP 132′. This web framework component 133, for example, provides the PYZ APP 132′ access to the resources and data stored in the database 134 of the home server 130 as well as templating frameworks, session management and code reuse.

Within the web framework 133 is an Application Programming Interface (API) module 133a, a registration module (RM) 133b, and a data parser (DP) 133c. The API module 133a functions to specify how the system 120 requests, retrieves, and may share data from servers and other computers and the like outside of the system 120. The API module 133a also functions to facilitate the interaction of the various software, components, modules, with each other, and also interactions with other servers and the like outside of the system 120, such as the social network server (SN) 82.

The registration module 133b functions to handle manual registrations. The data parser 133c functions to read information, data, and the like, in various formats, text, graphics, and the like, and break or parse text into words, phrases, portions, units, segments, groups of letters, and other combinations, from data which may be unrecognizable (by humans when the data is in text form), but, usable by the web framework and other components of the system 120 for their processes, functions, operations, storage, and the like.

While the web framework 133, database(s) 134, and PYZ APP 132 and PYZ widget 132a, are all shown as components of the home server 130, any one or more of these components could be located elsewhere within the system 120, or outside of the system 120, and the system 120 may still deliver the stated functionality. These components may also be multiple components, linked together through the network 15.

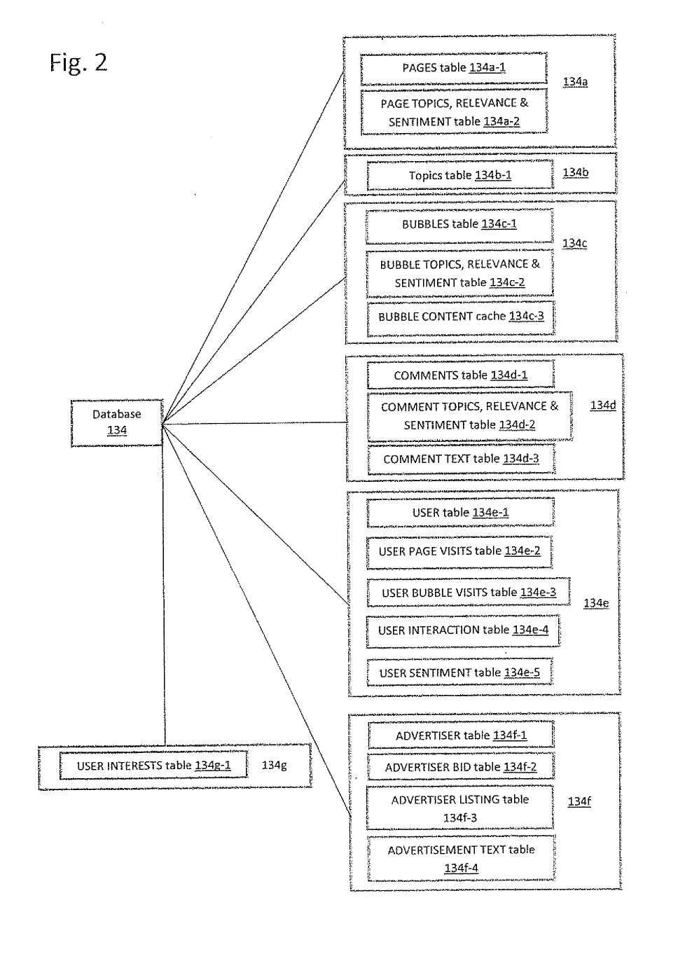

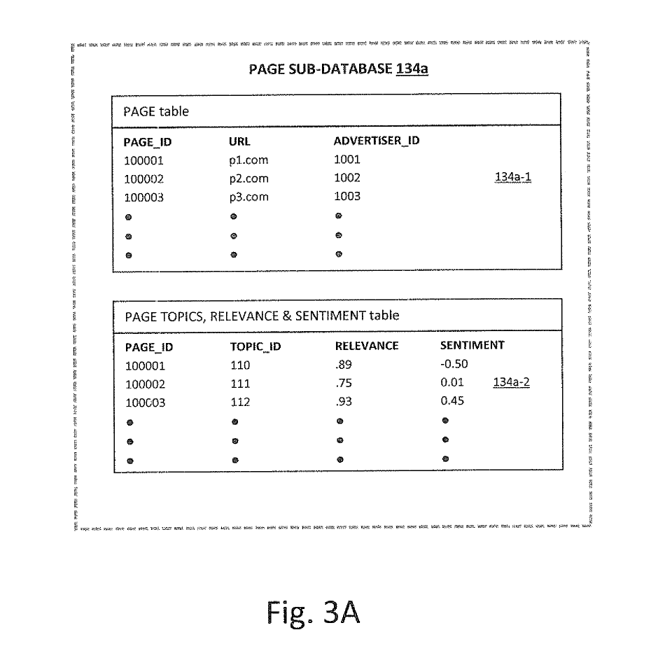

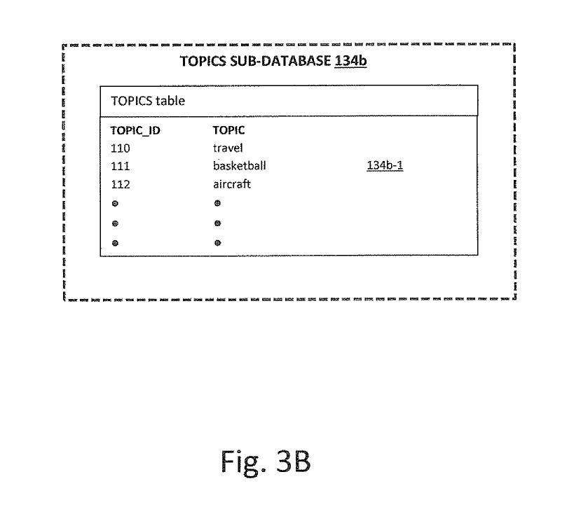

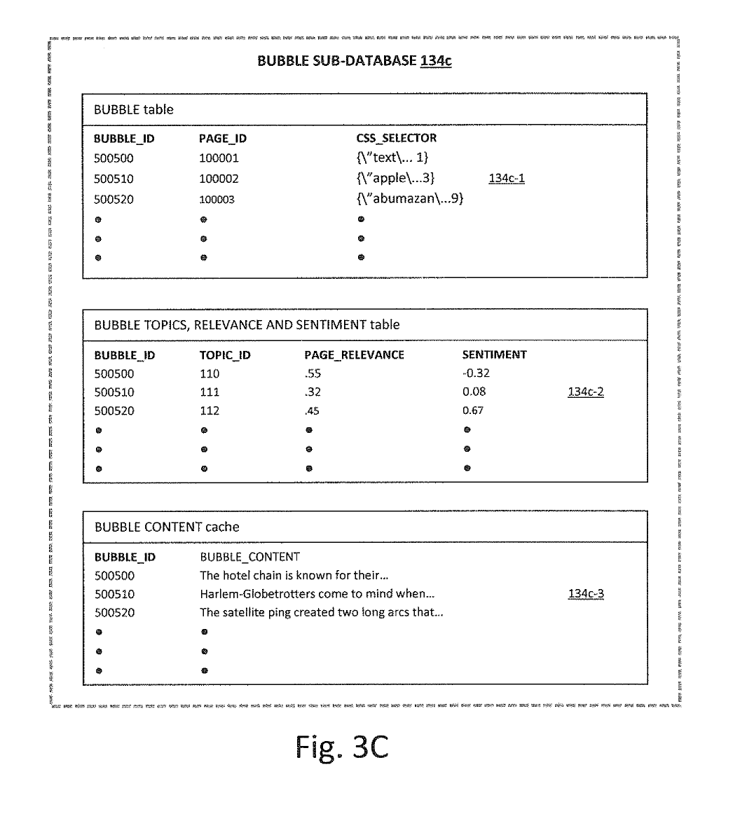

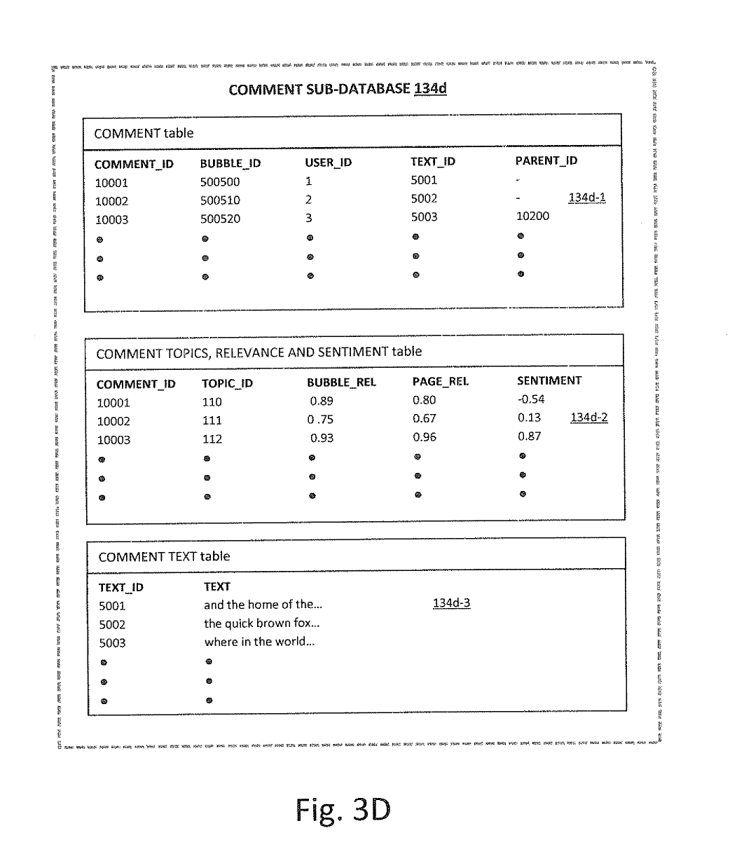

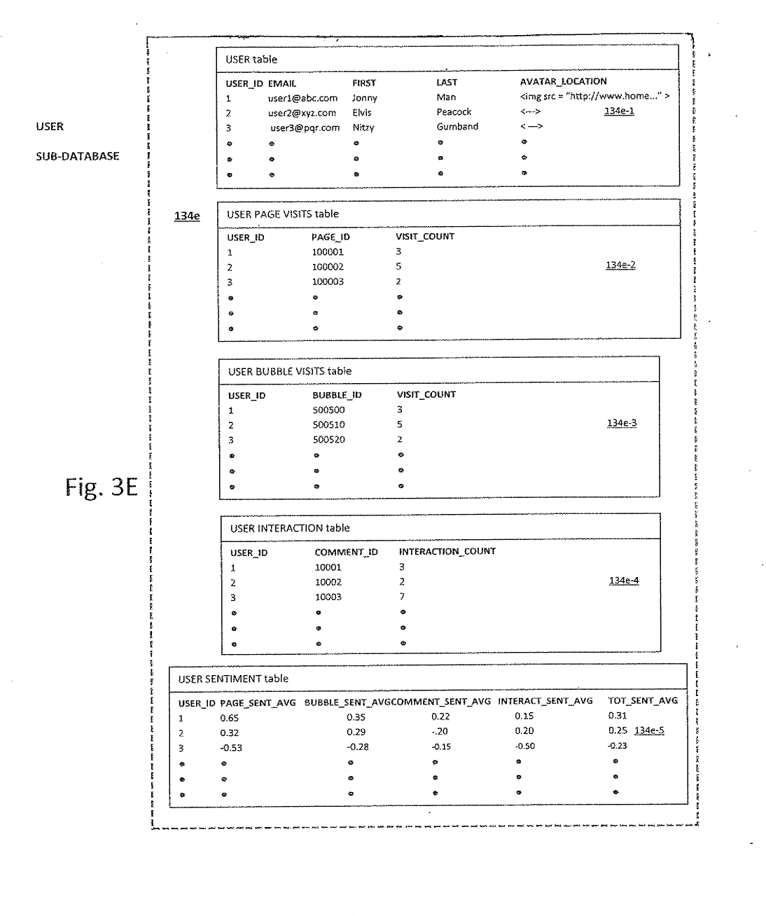

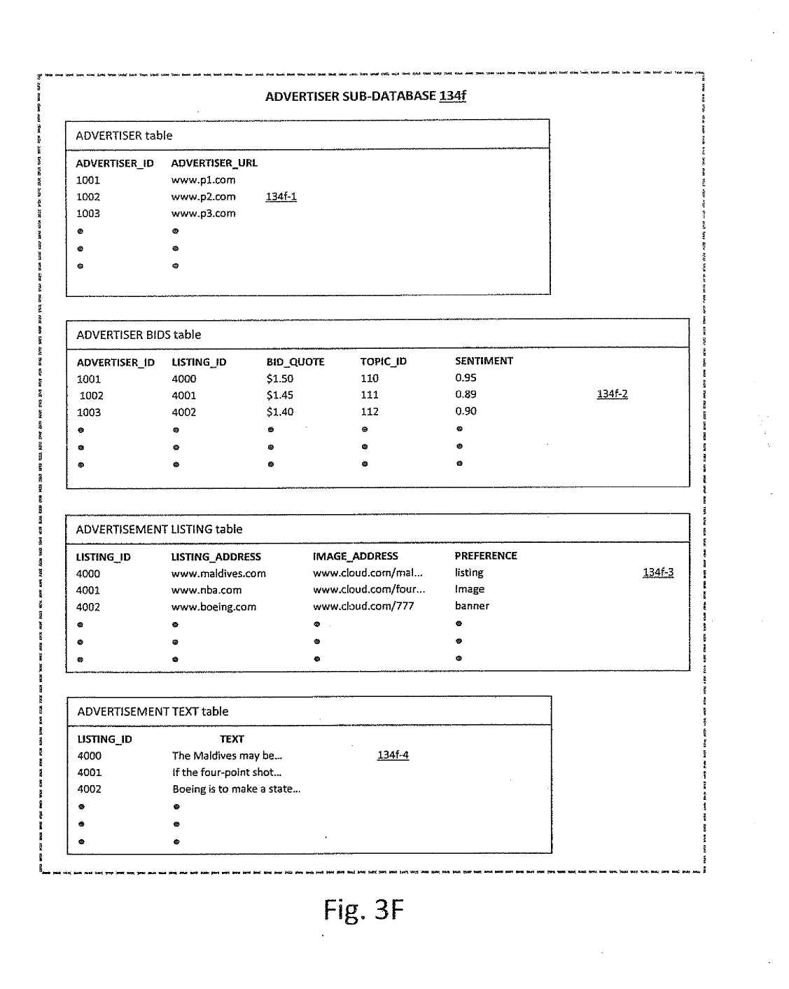

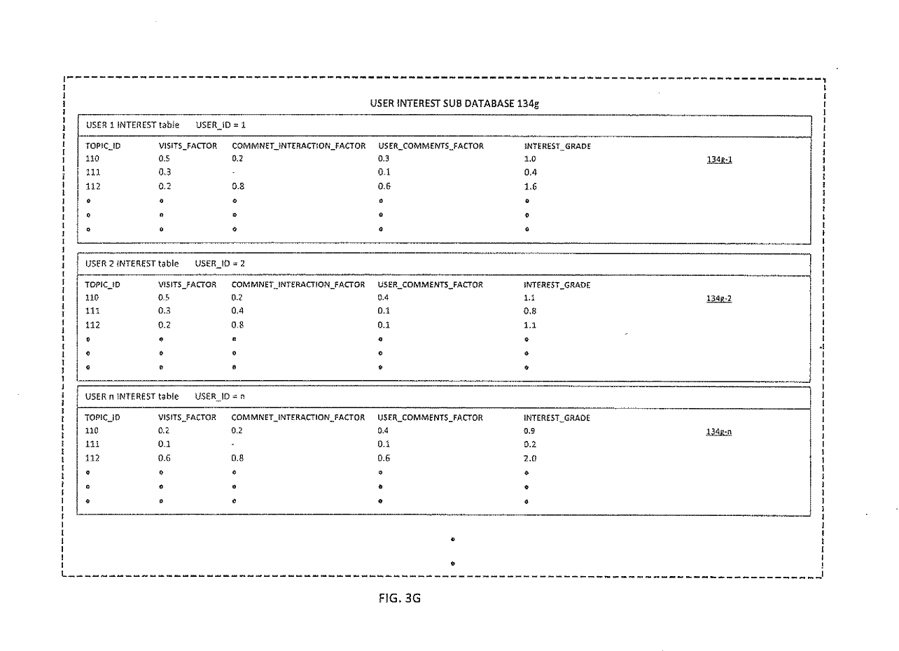

Attention is now also directed to FIG. 2, in which the database(s) 134 is displayed. The database 134 includes subdatabases 134a-134g, each containing tables with fields, as shown in FIGS. 3A-3G. The Fields are in accordance with their names, with ID, as used in the fields being a unique Identifier or Identification. For example, the field COMMENT_ID lists identifiers or reference numbers for comments, the identifiers, for example, in the form of numerals, letters, characters or combinations thereof. The subdatabases and tables shown and described herein are exemplary only and other subdatabases and tables may be added as needed.

Page sub-database 134a includes a Page Table 134a-1 and a table for page topics, relevance and sentiment 134a-2. These tables are used as references and data aggregators for the URLs, that become part of the system 120, resulting from a publisher's integrating or embedding the PYZ APP 132′ or widget 132a′ into the code of the server that supports the URL and subsequent USER interactions with the functionality created by the PYZ APP 132′. The PAGE table 134a-1 includes fields for PAGE_ID, URL, and ADVERTISER_ID. As shown in FIG. 3A, the Page Topics, Relevance and Sentiment Table 134a-2 includes fields for PAGE_ID, TOPIC_ID, RELEVANCE and SENTIMENT.

The Topics sub-database 134b includes a Topics table 134b-1. This table 134b-1 stores and maintains all of the topics in natural language that are entered into or designated by the system, for example, via Pages, Bubbles, or Comments. As shown in FIG. 3B, the Topics Table 134b-1 includes the fields TOPIC_ID, and TOPIC, which is a listing of an actual topic in natural language text, which can be referenced by the system 120 so as to be searchable.

Bubble sub-database 134c includes a BUBBLE table 134c-1, a BUBBLE_TOPICS, RELEVANCE and SENTIMENT table 134c-2, and a BUBBLE COMMENT Table/Cache 134c-3. These tables 134c-1, 134c-2, 134c-3 are used as references and data aggregators for the various bubbles (BUBBLE), that become part of the system 120, in accordance with the actions tracked by the system 120. As shown in FIG. 3C, the BUBBLE table 134c-1 includes fields for BUBBLE_ID, PAGE_ID, and CSS_SELECTOR. The CSS_SELECTOR field lists information regarding where the bubbles (with BUBBLE_ID as an identifier) should appear, i.e., location, on a web page, typically referencing a specific HTML element within the web page, next to which the comment icons are designated to appear. BUBBLE TOPICS, RELEVANCE and SENTIMENT table 134c-2 includes the fields of BUBBLE_ID, TOPIC_ID, PAGE_RELEVANCE, and SENTIMENT_SCORE, with SENTIMENT_SCORE and PAGE_RELEVANCE values listed as an assigned computer generated score for a specific element within a web page and to which a bubble (with a specific BUBBLE_ID) refers. BUBBLE CONTENT cache 134c-3 includes the fields BUBLE_ID and BUBBLE_CONTENT, which allows the system 120 to temporarily store and subsequently analyze the content within a web page, that is associated with a specific BUBBLE_ID.

The COMMENT sub-database 134d includes a COMMENT table 134d-1, a COMMENT, TOPICS, RELEVANCE and SENTIMENT table 134d-2, and a COMMENT TEXT table 134d-3. These tables 134d-1, 134d-2, and 134d-3, are used as references and data aggregators for comments made by users of the system 120.

As shown in FIG. 3D, the Comment Table 134d-1 includes the fields COMMENT_ID, BUBBLE_ID, USER_ID, TEXT_ID, and PARENT_ID. The USER_ID is an identifier for the actual user who posted the particular comment corresponding to the COMMENT_ID from the same row of the Table 134d-1. The TEXT_ID is an identifier, which is used to retrieve the actual text of the posted comment, when requested by a user of the system 120 to be displayed (via a COMMENT BOX GET REQUEST). The PARENT_ID is an identifier for a previously posted comment; depending on whether there is a value in the PARENT_ID field of a row in the COMMENT table 134d-1. A PARENT_ID value signifies that the comment referenced by COMMENT_ID in that row was a reply comment. The COMMENT TOPICS, RELEVANCE and SENTIMENT table 134d-2, includes the fields COMMENT_ID, TOPIC_ID, BUBBLE_REL (RELEVANCE), PAGE_REL (RELEVANCE), and SENTIMENT, with the RELEVANCE and SENTIMENT values listed as an assigned computer generated score for a specific element within a web page and to which a bubble with a specific BUBBLE_ID refers. COMMENT TEXT Table 134d-3 includes the fields COMMENT_TEXT_ID and TEXT.

The User sub-database 134e includes a USER table 134e-1, a USER PAGE VISITS table 134e-2, a USER BUBBLE VISITS table 134e-3, a USER INTERACTION table 134e-4, and a USER SENTIMENT table 134e-5. These tables 134e-1 to 134e-5 are used as references and data aggregators, which store and maintain information about the users of the system 120, and their interaction with the various components of the system 120. As shown in FIG. 3E, the USER table 134e-1 includes fields for USER_ID, EMAIL, which is the user's e-mail address associated with the USER_ID, FIRST, the first name of the user associated with the USER_ID, LAST, the last name of the user associated with the USER_ID, and AVATAR_LOCATION, the address of the web resource, which holds the user's avatar picture associated with the USER_ID. The USER PAGE VISITS table 134e-2 includes the fields USER_ID, PAGE_ID, and VISIT_COUNT. The USER BUBBLE VISITS table 134e-3 includes the fields, USER_ID, BUBBLE_ID, and VISIT_COUNT. The USER INTERACTION table 134e-4 includes the fields, USER_ID, COMMENT_ID, and INTERACTION_COUNT and is used, for example, to keep track of which user's comments a user has interacted with. The USER SENTIMENT table 134e-5 includes the fields, USER_ID, PAGE_SENT (SENTIMENT)_AVG (AVERAGE), BUBBLE_SENT (SENTIMENT)_AVG (AVERAGE) and COMMENT_SENT (SENTIMENT)_AVG (AVERAGE), INTERACT (INTERACTION)_SENT (SENTIMENT)_AVG (AVERAGE), an aggregate SENTIMENT_SCORE for all of the comments interacted with by a user, and TOTAL_SENT (SENTIMENT)_AVG (AVERAGE), the sentiment average for the fields: PAGE_SENT_AVG, BUBBLE_SENT_AVG and COMMENT_SENT_AVG. The USER SENTIMENT table 134e-5 is used, for example, to track the tone of the text produced by, read and interacted with by the USER.

The Advertiser sub-database 134f includes an ADVERTISER table 134f-1, an ADVERTISER BIDS table 134f-2, an ADVERTISEMENT LISTING table 134f-3, and an ADVERTISEMENT TEXT table 134f-4. As shown in FIG. 3F, the ADVERTISER table 134f-1 includes the fields ADVERTISER_ID and ADVERTISER_URL. The ADVERTISER BIDS table 134f-2 includes the fields, ADVERTISER_ID, LISTING_ID, BID_QUOTE, TOPIC_ID, and SENTIMENT, which is for example, a sentiment score, as detailed in tables 134a-2, 134c-2 and 134d-2, above. BID_QUOTE is for example a pay per click (PPC) or cost per click (CPC) amount, but could also be any other payment amount, such as cost per impression, cost for conversion, and the like whereas LISTING_ID, for example, allows for one advertiser to have multiple advertisements or listings in the system 120. In this table 134f-2, SENTIMENT, representing a sentiment score, is an assigned value by the sentiment analysis server 77, which lists the sentiment score for the Advertising listing itself.

The ADVERTISEMENT LISTING table 134f-3 includes the fields, LISTING_ID, LISTING_ADDRESS, such as an address (URL) for a web page or web site, IMAGE_ADDRESS, the web location of the associated image, and a PREFERENCE. An entry in the PREFERENCE field allows, for example, an advertiser to manage different types of advertisements and campaigns through the system. The ADVERTISEMENT TEXT table 134f-4 includes the fields, LISTING_ID and TEXT.

The User Interest Subdatabase 134g includes USER_INTEREST tables 134g-1, 134g-2 to 134g-n. These tables 134g-1, 134g-2 to 134g-n, for example, represent User1 61 (134g-1), User2 62 (134g-2) and Usern (134g-n), and include the fields, TOPIC_ID, VISITS_FACTOR, BUBBLE_VISITS_FACTOR, COMMENT_INTERACTION_FACTOR, USER_COMMENTS_FACTOR, and INTEREST_GRADE.

The VISITS_FACTOR field holds a value that is the percentage of time a TOPIC_ID is present on a web page or BUBBLE, e.g., inside the content within a comment box, that a user visits. The COMMENT_INTERACTION_FACTOR field is the percentage of comments the user interacts with that contain a certain topic with TOPIC_ID. For example, in the table 134g-1, Topic 112 for the TOPIC_ID field has been present in 80% of the comments the USER has interacted with.

The USER_COMMENTS_FACTOR field represents the percentage of times that a specific topic (represented by a TOPIC_ID) is contained inside the user's comment. The INTEREST_GRADE field is the sum of the aggregate total for scores on a topic for each TOPIC_ID.

There is also an analytics engine 135, which allows the PYZ APP 132′ to distinguish between the various HTML elements contained within a web page or web site, and is associated with the CSS Selector detailed herein. A registration module 136, is where publishers, for example, publishers P1-Pn who want to host the PYZ application 132 or PYZ widget 132a, complete an on-line registration process for access to the application 132 or widget 132a, of the system 120, or the application server 71. The registration module also stores the registration information for the publishers who have embedded or integrated the application 132 or the widget 132a.

The system 120, and for example, the home server 130 also includes a content recommendation engine 140, an information/content interface 141, and, an element analyzer 142. The information/content interface 141 allows publishers to administer and control the optional content, for example, to the numbers of users, and the types of users, to whom the publisher will present or display the optional content or information is, and/or the traffic associated with the content providers' information providing or advertising budget.

The element analyzer 142 enables the PYZ APP 132′ to distinguish between the various HTML elements which a user drags his pointing device, e.g., mouse, over functions associated with element analyzer are also associated with the analytics engine 135, as described above. These components 140, 141, 142 are typically part of the home server 130, either internal or external thereto (as shown), and are part of the system 120.

The server 70, known as the YZ Server, with a URL of www.yzserver.com, hosts a website, that hosts content, comments and information, associated with the disclosed subject matter. For example, the server 70, is a portal web site, which hosts links containing portions (snippets) of the activity that has occurred on the web documents, and web pages associated with the PYZ APP 132, 132′(when the PYZ APP 132 is embedded or integrated into the web pages or web sites). The aforementioned web documents contain comments made by users of the system 120 in reference to the content of the underlying web pages, as well as information, e.g., link recommendations for content, that have related relevancy to the underlying web pages to which the users' comments are associated.

Web browsers (also known as browsing applications, browser applications, or browsers, and used interchangeably herein) of computers linked to the network 15 can be directed to the web site hosted by this server 70 to view the various portions (snippets) of comments and web pages associated therewith in aggregated form. This web site, as hosted by the server 70, is a portal from which users can redirect their browsing applications to the actual web pages, for example, those of the publishers, P1, P2, P3, on which comments have been posted. This YZ Server 70 may be part of the system 20.

For example, the server 70, aggregates information associated with users, web pages (with the PYZ APP 132′ integrated or embedded therein) and comments made to the various web pages, and may also be programmed to facilitate group commenting, private commenting viewable only to specific users, as well as other types of user or group specific commenting that may associate groups of users with privately created web documents, hosting textual, audio or video content, or combinations thereof, for specific users of the system 120. These groups and private commenting sessions may, through the server 70, link the users associated with these groups with similar web sites or web pages in addition to creating customizable web documents for users with similar commenting preferences, content or conversation readership, and/or related browsing histories. Also, these private sessions may be created and/or administered directly by the users of the system 120. While users 61, 62, as shown, may access the system 120 and server 70 through their computers 61′, 62′, the system 120 and server 70 may also be accessed via mobile devices, such as smart phones, tablet computers, such as Ipads®, and the like.

The server 70 may be programmed to notify the users of these groups, via existing social network or e-mail accounts, pop-ups, and the like. The server 70 may also be programmed to place all of these users in contact with each other, via a chat room, a temporarily created web document, or web page, or automatically create a group of these users (in accordance with their desires) through social media grouping functions, such as Facebook®, Google Groups, or the like. By creating these groups, users have the ability to communicate with specific users over the network 15. In this case, the server 70 is part of the system 120, with access to the home server 130 and all components thereof.

The servers 130, 50a-50n, 60, 62, and 70-77 typically also have internal storage media and/or are associated with external storage media. In a typical environment, the system 120 is independent of, and not related to or controlled by, the parties associated with the publishers (represented by publisher servers P1-Pn 50a-50n) and the social network server 62, and in some instances, the application server 71.

The home server 130 also includes, for example, a document module (DM) 137a which stores document data such as addresses for images, image data itself and other aspects of the web documents used to support comments and information links on web pages. There is also a filter module (FM) 137b, to edit, toggle on/off, or filter certain comments (e.g., improper language, disparaging or slanderous comments). There is an administration module (ADM) 137c, which functions to administer all of the components of the home server 130 and the system 120, where necessary. These modules 137a-137c are accessible by a system administrator, either directly through the system 120, or over the network 15, to allow manual functions, such as adding/changing settings, filtering, and handling of user comments as well as other manipulations, as well as access to any other components of the home server 130 and the system 120.

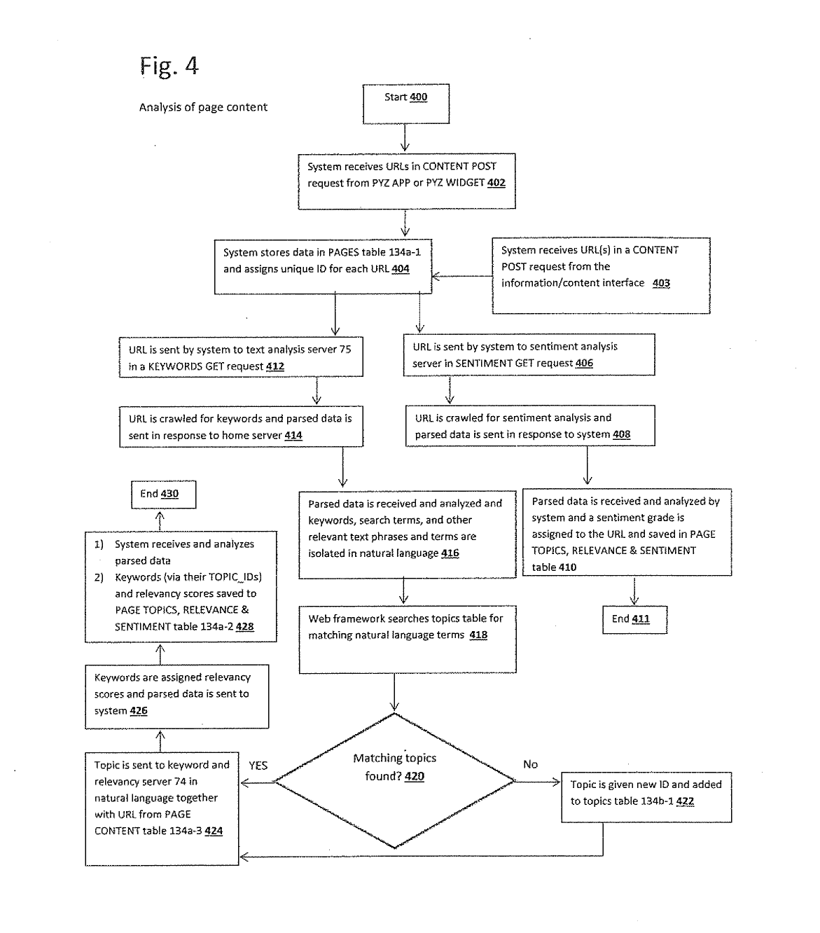

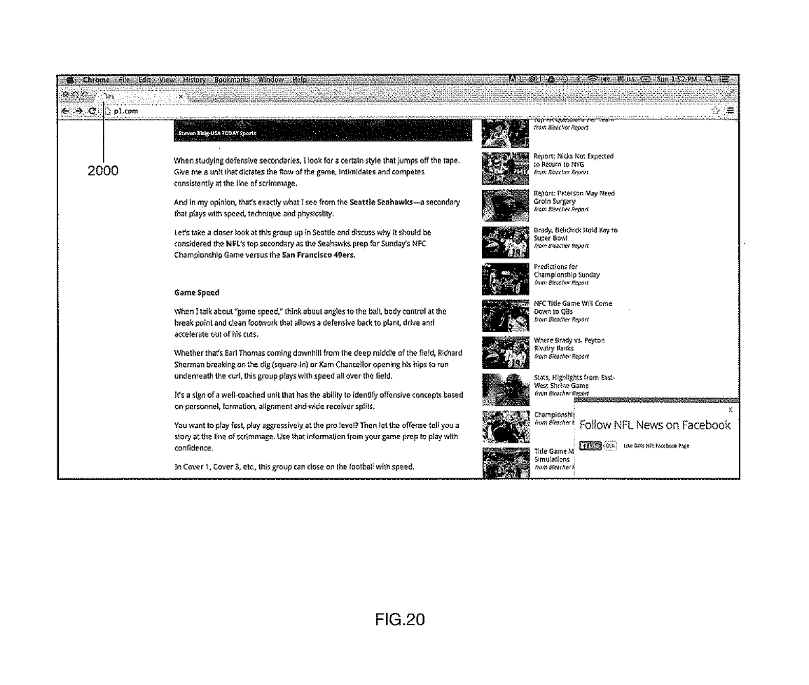

The home server (HS) 130 also includes various processors 138, including microprocessors, a Central Processing Unit (CPU), for performing the server functions and operations detailed herein, including the processes and subprocesses detailed in FIGS. 4-19 (with portions illustrated in FIGS. 20-29), as detailed below, and storage media 139, either internal or external, or associated therewith. The processors 138 control the operation of the components 132, 132a, 133, 133a, 133b, 133c, 134, 136, 137a, 137b, 137c, 139 of the system 120 and the home server 130. The processors 138 are, for example, conventional processors, such as those used in servers, computers, and other computerized devices. The processors 138 may be arranged to have a central processing unit (CPU), for controlling the home server 130 (and components associated therewith). For example, the processors 138 may include x86 Processors from AMD and Intel, Xenon® and Pentium® processors from Intel, as well as any combinations thereof.

The storage/memory 139 is any conventional storage media. The storage/memory 139 stores machine executable instructions associated with the operation of the components 132, 132a, 133, 133a, 133b, 133c, 134, 136, 137a, 137b, 137c, 138 of the home server 130 (and the components associated therewith), an all instructions for executing the processes of FIGS. 4-19 detailed herein. The storage/memory 139 also stores rules and policies for the system 120 and the home server 130. The processors 138 and the storage/memory 139, although shown as a single component for representative purposes, may be multiple components, and may be outside of the home server 130 and/or the system 120, and linked to the network 15.

Attention is now directed to FIGS. 4-19, which are flow diagrams detailing a computer-implemented process in accordance with embodiments of the disclosed subject matter.

Reference is also made to elements shown in FIGS. 1A, 1B, 2, and 3A-3G. The process and subprocesses of FIGS. 4-19 are computerized processes performed by the system 120 in conjunction with the client, for example the PYZ APP 132′, and the PYZ widget 132a′, deployed, for example on the publisher servers P1-Pn 50a-50n. The aforementioned processes and sub-processes can be, for example, performed manually, automatically, or a combination thereof, and, for example, in real time. Reference is also made to the screen shots of FIGS. 20-29, which appear on the monitor of the computer of a user, when describing the processes of FIGS. 4-19, as detailed below.

FIG. 4 is a process, including subprocesses, that describes URL analysis.

Prior to the start of the process detailed in FIG. 4, the PYZ APP 132′ has been installed by the publisher, on the respective publisher server, for example, on the servers of Publishers P1 50a, P2 50b, P3 50c, and, the PYZ widget 132a′ has been installed on publisher server P4 50d as shown in FIG. 1A. The PYZ APP code or widget code has been embedded into the code of the Publisher's web site on the aforementioned servers, or an advertiser, or “publisher”, has chosen to carry out a campaign with predefined content uploaded to the system 120 via the information/content interface 141 and sent directly to designated web documents in accordance with the rules and policies of, at least, the campaign, the system 120 or a combination thereof.

The PYZ widget 132a′ differs from the PYZ APP 132′ for example, as the widget 132a′allows a publisher to upload content directly and automatically to the system 120. However, the PYZ widget 132a′ does not necessarily create the commenting functionality on webpages.

Attention is now directed to the START block 400. At block 400, the system 120 receives content (in the form of URLs) from an information provider/affiliate either (represented by Publisher 1 (P1) 50a, Publisher 3 (P3) 50c or Publisher 4 (P4) in the case of the widget 132a′ 50d of FIG. 1) automatically from the embed code 132′ or widget 132a′ installed on the publisher site, or, manually, through the information/content interface 141.

From block 400, the process moves to block 402. At block 402, the system 120 receives URLs in CONTENT POST requests, from the PYZ APP 132′ embedded on the hosted (e.g., by the publisher) web site. From block 402, the process moves to block 404 where the system 120, acting via the web framework 133, stores the URLs, received by the system 120 at previous block 402, by assigning each URL with a unique identifier ID in a new entry in the PAGES table 134a-1.

Block 404 is also accessed from block 403. At block 403, the system 120 receives URLs in a CONTENT POST request from the information/content interface 141. From block 404, the process moves to both blocks 406 and 412.

At block 406, the system 120 sends the PAGE's URL in a SENTIMENT GET request to the third party sentiment analysis server 77. For example, sentiment analysis carried out may be in accordance with ALCHEMYAPI™ (www.alchemyapi.com), from the AlchemyAPI, Inc. of Denver, Colo. 80202, USA. The process moves to block 408 with the receipt, by the sentiment analysis server 77, of the SENTIMENT GET request. At block 408 the URL's content is crawled for terms, for example, adjectives signifying a positive or negative tone. For example, the word “good” represents a positive sentiment and the word “bad” represents a negative sentiment, and parsed data containing the results of the sentiment analysis of sentiment analysis server 77 is sent to the system 120.

The process moves to block 410 where the system 120 receives the parsed data (the data having been parsed at sentiment analysis server 77), analyzes it and a sentiment grade is assigned to the URL that was given a unique PAGE_ID at previous block 404. At block 410, the sentiment grade is saved in the sentiment column of the entry in the PAGE TOPICS, RELEVANCE & SENTIMENT table 134a-2 containing the unique PAGE_ID generated at previous block 404. From block 410 the process moves to block 411 where it ends.

Moving to block 412 from block 404, the system 120 sends the URL in a KEYWORDS GET request to the third party text analysis server 75. Once received by the text analysis server 75, the process moves to block 414 where the URL is crawled for, for example, keywords, search terms and other relevant text phrases. Also at block 414, parsed data is sent to the system 120 with the results of the keyword analysis performed by text analysis server 75. The results of the analysis performed by text analysis server 75 may include, for example, words, terms, phrases and sayings in natural language.

From block 414, the process moves to block 416 where the system 120 receives the response of the text analysis server 75 to the KEYWORDS GET request by receiving parsed data containing keywords, search terms and other relevant text phrases. Also at block 416, the system 120 isolates, in natural language, the keywords, search terms and other relevant text phrases received by the system 120 from the text analysis server 75 in parsed data.

Once isolated by the system 120 in natural language at block 416, the process moves to block 418, at which point the web framework 133 searches the TOPICS table 134b-1 for matching natural language terms to those which were received from the text analysis server 75 in parsed data at previous block 416.

From block 418, the process moves to block 420, where the web framework 133 determines whether there are matching natural language words, terms or phrases in the TOPICS table 134b-1 to those received by the system 120 (at previous block 416). If matches are not found, the process moves to block 422.

At block 422, the web framework 133 assigns the new natural language term a unique ID and writes it (adds it) into the TOPICS table 134b-1. Once written (added) into the TOPICS SUB-DATABASE 134b, the process moves to block 424.

The process is now at block 424 (where the web framework 133 has either, determined that matching natural language words or terms do not exist in the database 134 or, found a matching natural language word or term in the TOPICS table 134b-1). At block 424, the correct natural language term has either been identified or written into the database (at previous blocks 420 or 422 respectively), the natural language word or term is sent to keyword and relevancy server 74 in natural language together with the URL of the page that was assigned a unique ID at previous block 404.

Moving to block 426, the keyword and relevancy server 74 receives the natural language word(s) or term(s) (depending on the page content for which the text analysis was carried out at previous block 414 there may be multiple natural language words or terms for one PAGE_ID), coupled with the URL of the page from which the aforementioned words or terms were generated in a RELEVANCY GET request. Once at least one topic and a URL are received by the keyword and relevancy server 74, an analysis is carried out regarding the relevancy of the natural language word(s) or term(s) to the content of the URL. For example, the keyword and relevancy server 74 uses LUCENE, commercially available as Apache Lucene™, from the Apache Software Foundation of Forest Hill, Md., USA. Once the analysis is complete, the keyword and relevancy server 74 assigns the parsed data keyword(s), which are natural language words or terms, and a relevancy score, which are sent to the system 120.

From block 426, the process moves to block 428. At block 428, the system 120 receives and analyzes the parsed data from the keyword and relevancy server 74. Also at block 428, the system 120 takes the relevancy score for each natural language word or term (generated at keyword and relevancy server 74 at block 426 in response to the RELEVANCY GET request of the system 120) and saves the score for the word or term in the PAGE TOPICS, RELEVANCE & SENTIMENT table 134a-2. With the relevancy score for each natural language word or term saved in the PAGE TOPICS, RELEVANCE & SENTIMENT table 134a-2, the process moves to block 430 where the process ends.

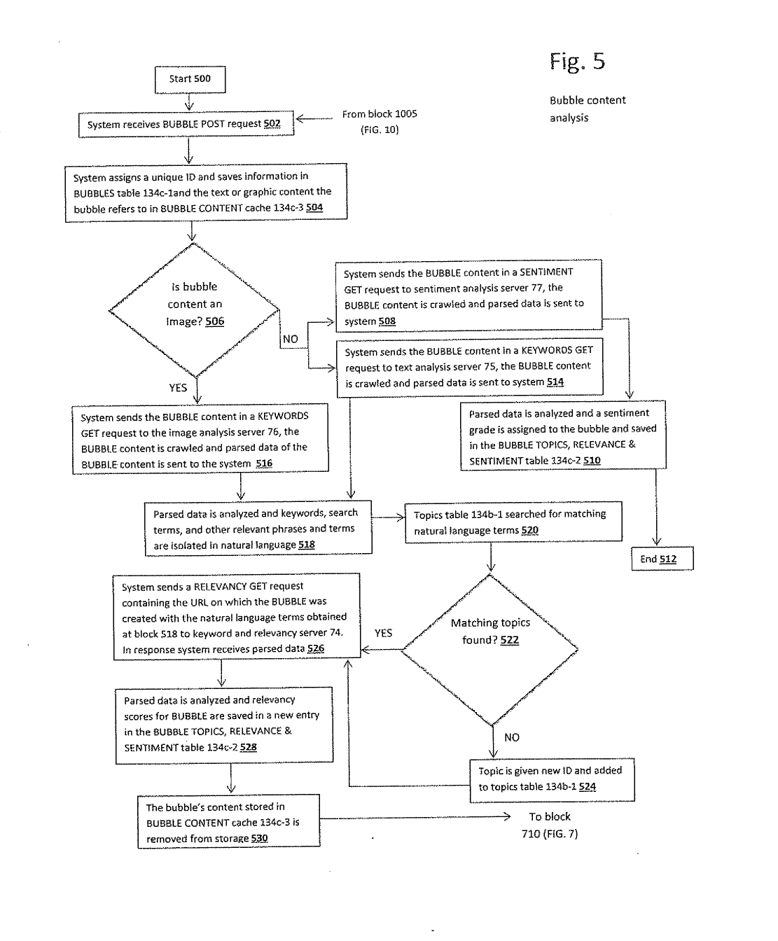

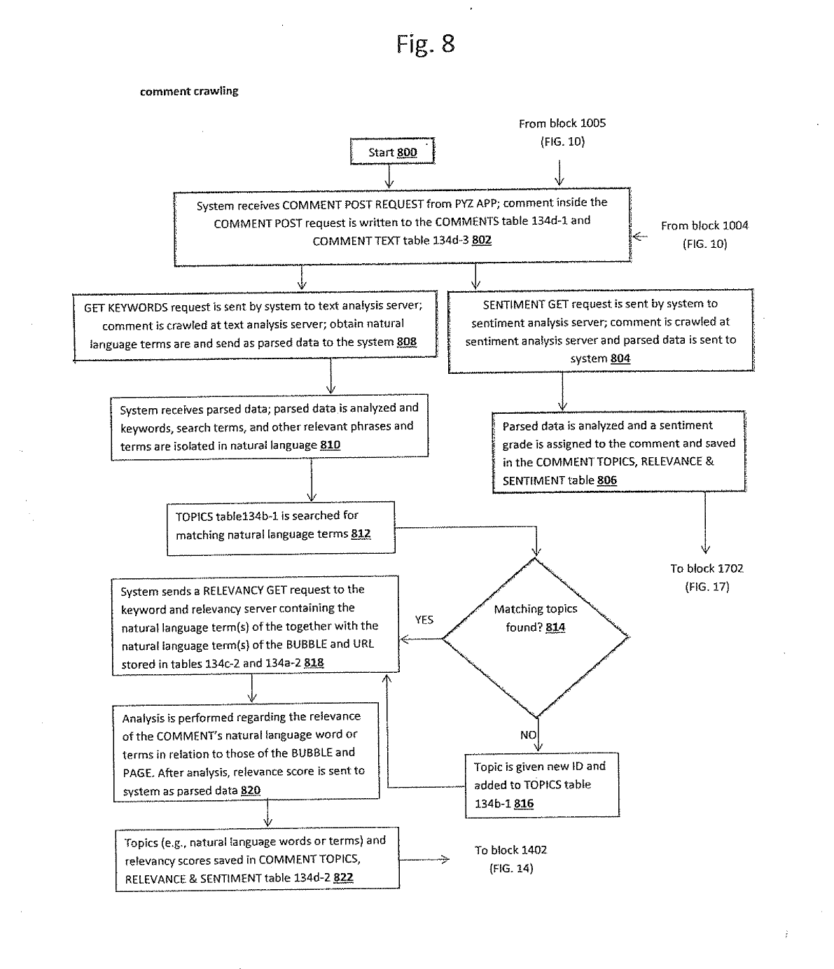

FIG. 5 details a process, including subprocesses, for bubble content analysis. Before the system 120 can undertake the processes associated with FIG. 5, the system 120 must have received a BUBBLE POST request. Additionally, the URL to which the user has directed his browsing application and from which the BUBBLE GET request was sent, must have been analyzed in accordance with the processes described in FIG. 4. For example, a user must direct his browsing application to a page on which the PYZ APP 132′ is embedded, click on a new comment icon and submit a comment, for example, in accordance with the processes detailed in FIGS. 8, 9 and 10. The process is now at the START block 500.

The process begins by moving to block 502, where the system 120 receives a BUBBLE POST request. This BUBBLE POST request indicates that the user has submitted a comment after having clicked on a new comment icon (if the user had clicked on a pre-existing comment icon and then submitted a comment, the process would not have been directed to FIG. 5 as the bubble's content would have been previously analyzed in accordance with the flow diagram associated with this FIG. 5).

From block 502, the process moves to block 504. At block 504, the system 120 creates a new entry in the BUBBLES table 134c-1. In the new entry in the BUBBLES table 134c-1, the system 120 assigns a unique ID to the BUBBLE, saves the PAGE_ID and CSS_SELECTOR (data stored within the CSS_SELECTOR column allows the system 120 to display comment icons next to the correct HTML element on the display monitor of the user when the URL is accessed by the user through his browsing application) enabling the system 120 to properly carry out BUBBLE GET requests for future visitors to the URL on which the BUBBLE was created. Also at block 504, the content (the specific content being of, for example, textual or graphic nature and to which the data stored in the CSS_SELECTOR column of the BUBBLES table 134c-1 refers) associated with the BUBBLE is stored, temporarily, in the BUBBLE CONTENT cache 134c-3. Moving to block 506, the content associated with the unique BUBBLE_ID, stored, temporarily, in the BUBBLE CONTENT cache 134c-3, is evaluated by the system 120 for the textual or graphical nature of its content. The evaluation, for example, is for determining whether the bubble content is an image. If, at block 506 the system 120 determines that the content is of a textual nature, and not an image or other graphic, the process moves, for example, to both blocks 508 and 514.

At block 508 the system 120 sends a SENTIMENT GET request including the textual content which was assigned a unique BUBBLE_ID, at previous block 504, to the sentiment analysis server 77, where it is crawled, for example, for the positive or negative tone of the adjectives included in the natural language text received from the system 120 in the aforementioned SENTIMENT GET request. When the analysis, or crawling, by the sentiment analysis server 77 is done and a sentiment score has been generated for the textual content, parsed data is sent by the sentiment analysis server 77 to the system 120. The parsed data sent to the system 120 by the sentiment analysis server 77 contains the score generated for the textual content.

From block 508 the process moves to block 510, where the system 120 analyzes the parsed data received from the sentiment analysis server 77, and, assigns a sentiment grade to the new BUBBLE_ID, that was entered into the BUBBLE TOPICS, RELEVANCE and SENTIMENT table 134c-2 (upon the receipt by the system 120 of a BUBBLE POST request, at precious block 502). This occurs after the BUBBLE POST request is received, and processed, by the system 120 (starting at block 502). From block 510, the process moves to block 512 where it ends.

If, at block 506, the system 120 determines that the content is of a textual nature, the process also moves to block 514. At block 514, the system 120 sends a KEYWORDS GET request, including the BUBBLE's content (the BUBBLE content that was received by the system 120 in the BUBBLE POST request at block 502 and stored in BUBBLE CONTENT cache 134c-3 at block 504), to the text analysis server 75. The bubble content is crawled for keywords (natural language words or terms) and parsed data is sent in response to the system 120. From block 514, the process moves to block 518. If, however, at block 506 the system 120 determines that the content of the new entry in the BUBBLE CONTENT cache 134c-3 is of a graphic nature, for example, an image, the process moves to block 516. At block 516, the system 120 sends the BUBBLE's content, in a KEYWORD GET request, to the image analysis server 76. The BUBBLE content is then crawled for keywords (natural language words or terms). Once the image analysis server 76 obtains natural language terms for the BUBBLE's content, it sends parsed data to the system 120, in response to the aforementioned KEYWORD GET request.

From block 514 and 516, the process moves to block 518. At block 518, the parsed data received by the system 120 from the text analysis server 75 or the image analysis server 76 is analyzed and the keywords, search terms, and, other relevant phrases and terms, obtained by the system 120 in parsed data in response to the KEYWORDS GET requests of either previous block 514 or 516, are isolated in natural language.

The process moves to block 520 where the web framework 133 searches the TOPICS table 134b-1 for matching natural language term(s), including words and phrases, to those that were isolated at previous block 518. From block 520 the process moves to block 522.

At block 522, the web framework 133 determines whether there are matching natural language terms in the TOPICS table 134b-1. If, at block 522, it is determined that matches do not exist, the process moves to block 524, where a new entry is created in the TOPICS table 134b-1 containing the natural language word or term that was determined by the system 120 not yet to exist. Also at block 524, this new entry is given a new unique ID, and is added to the columns TOPIC and TOPIC_ID of the TOPICS table 134b-1 respectively, for storage. From block 524 the process moves to block 526.

If, at block 522, it is determined that matches do exist in the TOPICS table 134b-1 (to the keywords isolated in natural language at block 518) the process moves to block 526. At block 526, the system 120 sends the URL of the PAGE on which the BUBBLE was created, together with all the topics obtained at previous block 518, in a RELEVANCY GET request to keyword and relevancy server 74. Also at this block 526, the keyword and relevancy server 74 responds to this request by sending parsed data to the system 120 containing the results of the analysis done on the data received from the system 120. This parsed data is then received by the system 120.

From block 526 the process moves to block 528. At block 528, the web framework 133 of the system 120 analyzes the parsed data (received by the system 120 from the keyword and relevancy server 74 in response to the RELEVANCY GET request) and saves the TOPICS (isolated in natural language at block 518) and the relevancy score (received from keyword and relevancy server 74 in response to a RELEVANCY GET request) for the BUBBLE (created at block 502 upon the system 120's receipt of a BUBBLE POST request) in new entry(s) in the BUBBLES TOPICS, RELEVANCE & SENTIMENT table 134c-2.

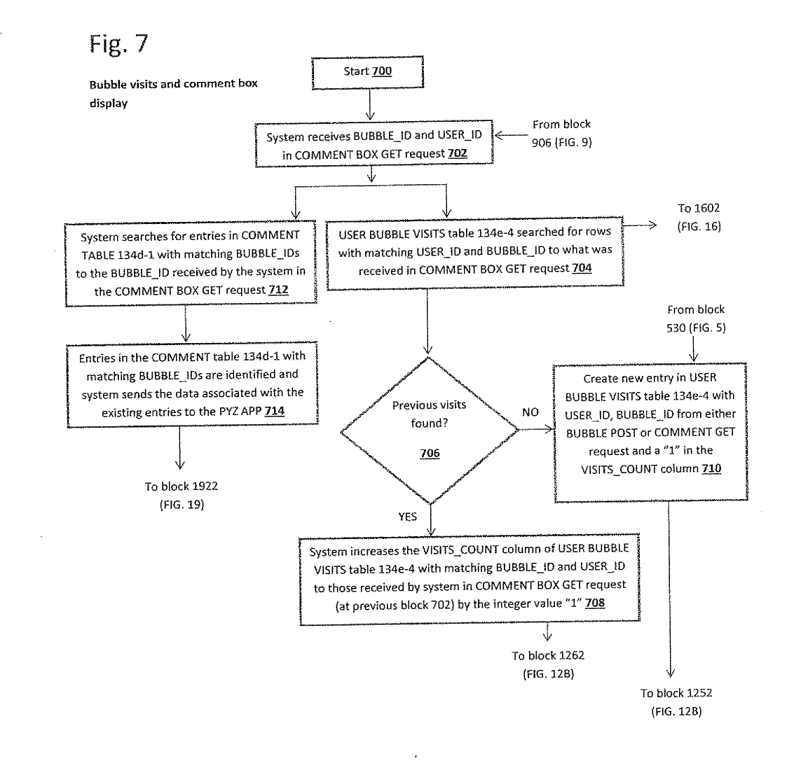

From block 528 the process moves to block 530. At block 530, the content, stored in the BUBBLE CONTENT cache 134c-3, and associated with the BUBBLE that was created in the BUBBLES table 134c-1 at previous block 504, is removed from the cache, e.g., storage. From block 530, the process moves to block 710 of FIG. 7.

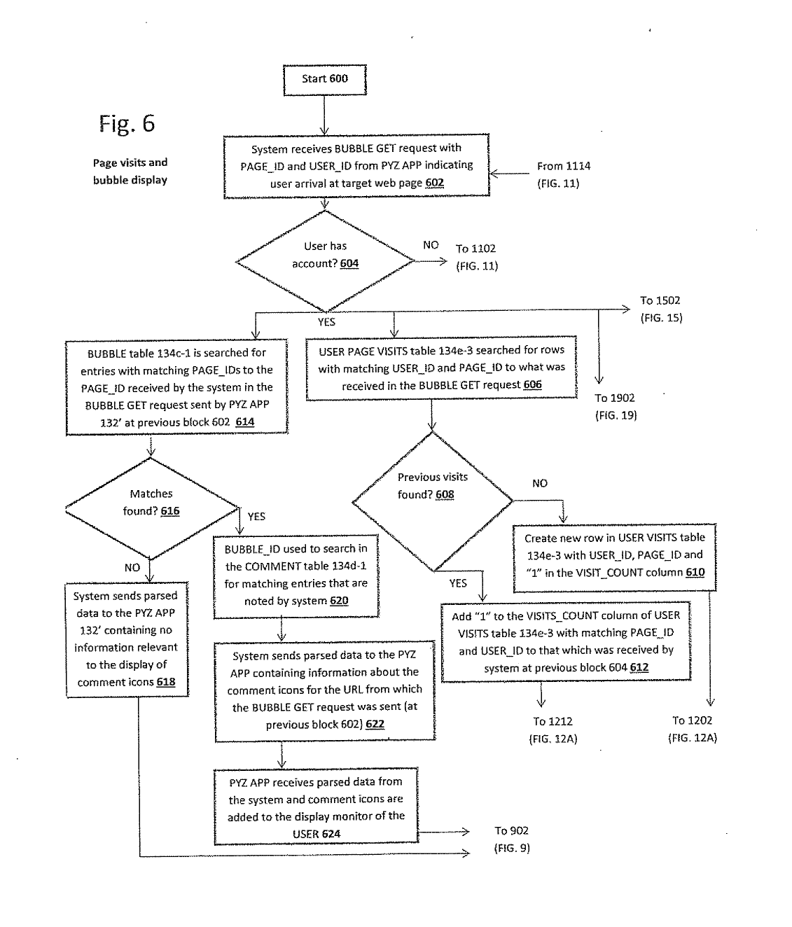

FIG. 6 details a process, including subprocesses, associated with recording user page visits and causing bubbles to display on the monitor of a user who has directed his browsing application to a URL on which the PYZ APP 132′ is embedded. The process starts at block 600. At or prior to block 600, the processes described in FIG. 4 for URL analysis have been carried out for the URL to which the USER has directed his browsing application.

The process begins by moving to block 602, where the system 120 receives a BUBBLE GET request from a PYZ APP 132′, indicating that a user, for example, user1 61, has directed his browsing application to a URL hosted by Publisher 1 (P1) server 50a, e.g., with the URL www.p1.com (Publisher 1 (P1) has the PYZ APP 132′ client side code embedded into the code associated with, at least, some its webpages). The BUBBLE GET request, sent by the PYZ APP 132′ and received by the system 120, contains the PAGE_ID of the URL and a USER_ID (if one is identified by the PYZ APP 132′) of the user, i.e., user1 61. This user1 61 has directed the browsing application of his computer 61′ to the target web page, here with the URL www.p1.com, which is now displayed on the monitor of user1's 61 computer 61′. The BUBBLE GET request is processed by the system 120 and the layer that supports web documents associated with the system 120 is added after the page loads, with the page loading represented by element 2000 of FIG. 20.

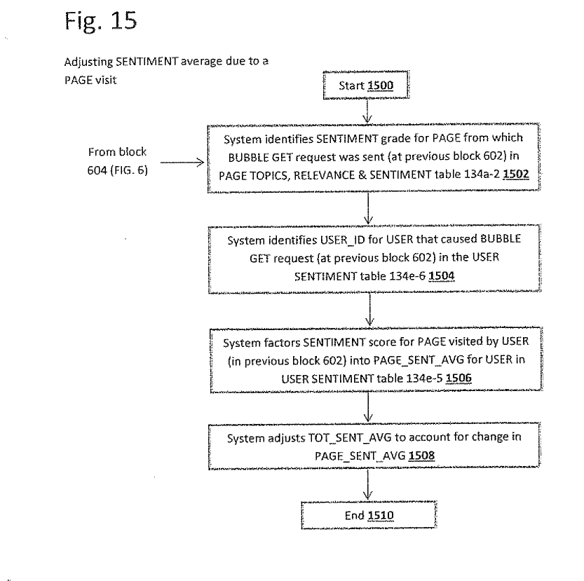

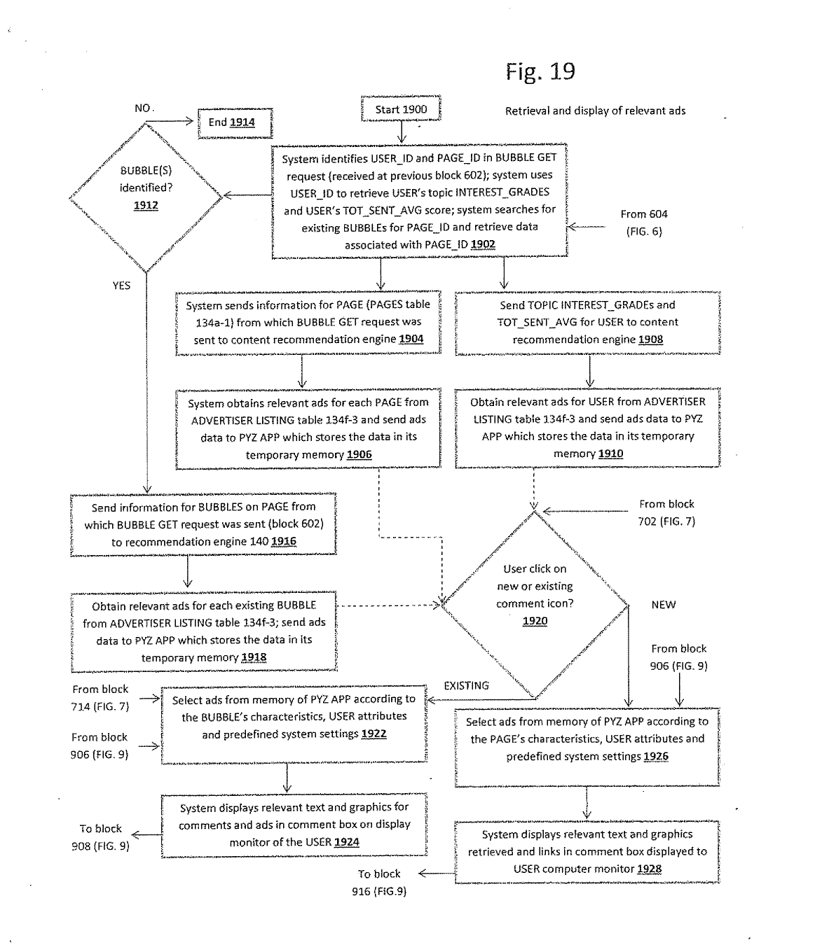

From block 602, the process moves to block 604, where the system 120 determines whether the user, who has directed his browsing application to the target web page (e.g., www.p1.com), has an account with the PYZ APP 132′. If, at block 604, it is determined that the user has not previously registered with the PYZ APP 132′ (as no user authentication has been identified by the system 120), the process moves to block 1102 of FIG. 11. If, however, at block 604 it is determined that the user does have an authenticated account with the system 120 (via the system 120 identifying a USER_ID in the BUBBLE GET request sent to the system 120 by the PYZ APP 132′), the process moves to blocks 606 and 614, to block 1902 of FIG. 19, and block 1502 of FIG. 15.

At block 606, the system 120 instructs the web framework 133 to search the USER PAGE VISITS table 134e-2 for entries (rows) with matching USER IDs and PAGE IDs, to the USER_ID and PAGE_ID that were received by the system 120 (at previous block 602), in the BUBBLE GET request.

From block 606 the process moves to block 608, where the system 120 determines whether the user has previously visited the target web page, e.g., URL. This determination is made by the system 120 searching the USER PAGE VISITS table 134e-2 for entries, with matching USER and PAGE IDs to those USER and PAGE IDs that were received by the system 120 in the BUBBLE GET request (at previous block 602). If no match is found, the process moves to block 610 where a new entry is created in the USER PAGE VISITS table 134e-3 containing the USER and PAGE IDs received in the BUBBLE GET request issued at previous block 604. Additionally at block 610, the integer “1” is entered in the VISIT_COUNT column of the new entry in the USER PAGE VISITS table 134e-2. From block 610, the process continues at block 1202 of FIG. 12A.

Returning to block 608, should the system 120 determine that there is an entry in the USER PAGE VISITS table 134e-3 with matching USER and PAGE IDs to those IDs that were received by the system 120 in the BUBBLE GET request (at previous block 602), the process moves to block 612. At block 612 the VISIT_COUNT field of the entry containing matching USER and PAGE IDs (to those IDs received by the system 120 in the BUBBLE GET request) is increased by an integer value of “1”. From block 612, the process continues at block 1212 of FIG. 12A.

Returning to block 604, the process, in addition to moving to block 606, also moves to block 614. At block 614, the system 120 searches for entries in the BUBBLE table 134c-1 with matching PAGE_IDs to the PAGE_ID that was received by the system 120 in the BUBBLE GET request sent by the PYZ APP 132′ (at previous block 602) (every URL that has embedded the client side code associated with the PYZ APP 132′ has a unique ID and has been analyzed in accordance with the processes outlined in FIG. 4 and, in some cases, FIG. 5).

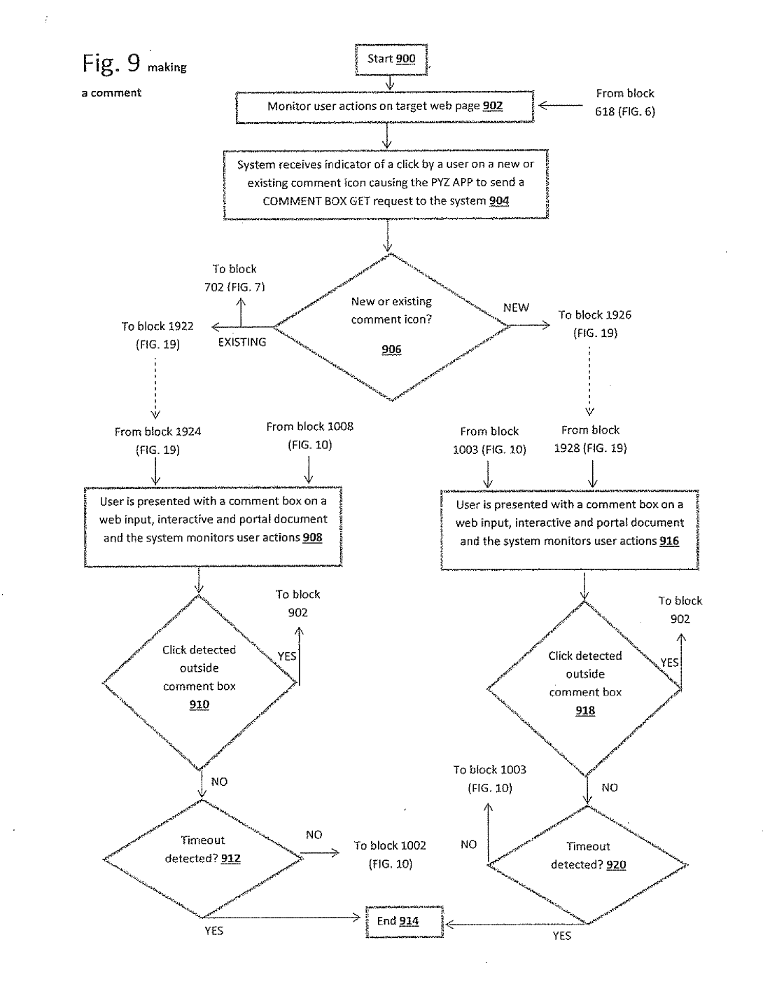

From block 614 the process moves to block 616 where the system 120 determines whether there are entries in the BUBBLE table 134c-1 that contain matching PAGE_IDs to the unique ID for the URL from which the BUBBLE GET request was sent at previous block 602. If, at block 616, the system 120 determines that no such entry(s) exists, the process moves to block 618. At block 618 the system sends parsed data to the PYZ APP 132′ containing no information relevant to the display of comment icons. From block 618 the process moves to block 902 of FIG. 9.

However, if at block 616 the system 120 identifies entry(s) in the BUBBLE table 134c-1 that contain matching PAGE_IDs to the unique ID for the URL from which the BUBBLE GET request was sent, the process moves to block 620. At block 620 the web framework 133 uses the BUBBLE_ID(s), of the entries in the BUBBLE table 134c-1 that were determined to have matching PAGE_ID values to the PAGE_ID of the URL from which the BUBBLE GET request was sent at previous block 602, to search for the number of entries in the COMMENT table 134d-1 that contain matching BUBBLE_ID(s) (this action is performed so that, when displayed to the USER via the display monitor of his computer, existing comment icons will have the correct number inscribed which informs the user of the amount of comments that are accessible for display after an activation, or click on, the comment icon).

From block 620, the process moves to block 622, where the system 120 sends parsed data to the PYZ APP 132′ containing information regarding the existing comment icons for the URL from which the BUBBLE GET request was sent at previous block 602 (for example, this data includes the amount of existing comment icons and what number should appear inscribed on it). For example, at previous block 620, the web framework 133, in searching the BUBBLES table 134c-1, retrieves the CSS_SELECTOR information for each bubble entry in the BUBBLE table 134c-1 that contain matching PAGE_IDs to the PAGE_ID that was received by the system 120 (at previous block 602).

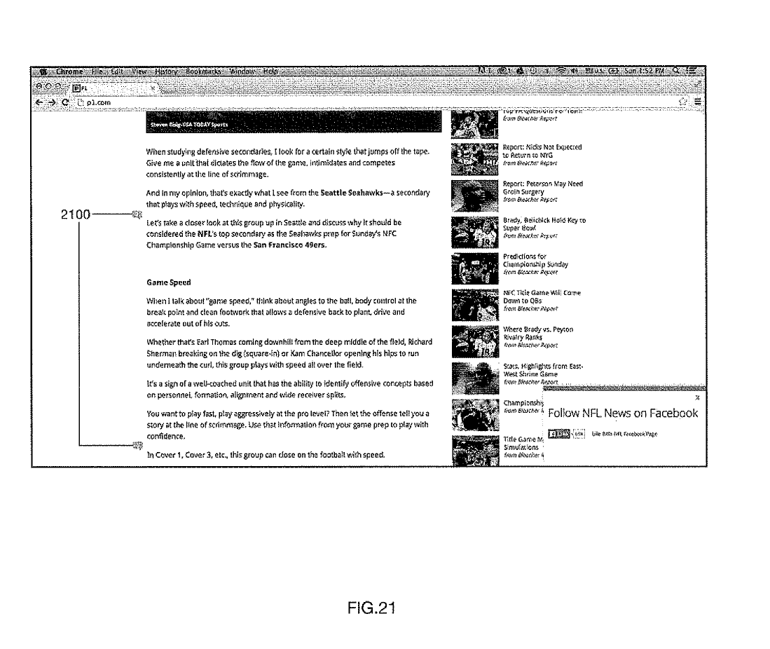

Once the PYZ APP 132′ receives parsed data from the system 120, the process moves to block 624. At block 624, comment icons, 2100 (FIG. 21), are added to the display monitor (e.g., of computer 61′) of the user (e.g., user1 61) in accordance with the information received from the system 120.

From block 624, the process moves to block 902 of FIG. 9, where user actions on the target web page are monitored.

Attention is now directed to the processes, including subprocesses for bubble visits and comment box display, shown in FIG. 7. At the START block 700, the user has completed the processes associated with FIG. 6 and the system 120 has analyzed the URL on which the user is now found in accordance with FIG. 4. Additionally, the processes associated with FIG. 5 may have taken place prior to the start block 700. However, for the purposes of this description, the processes associated with FIG. 5 have been performed at least once (at least one existing comment icon will appear on the display monitor of the USER).

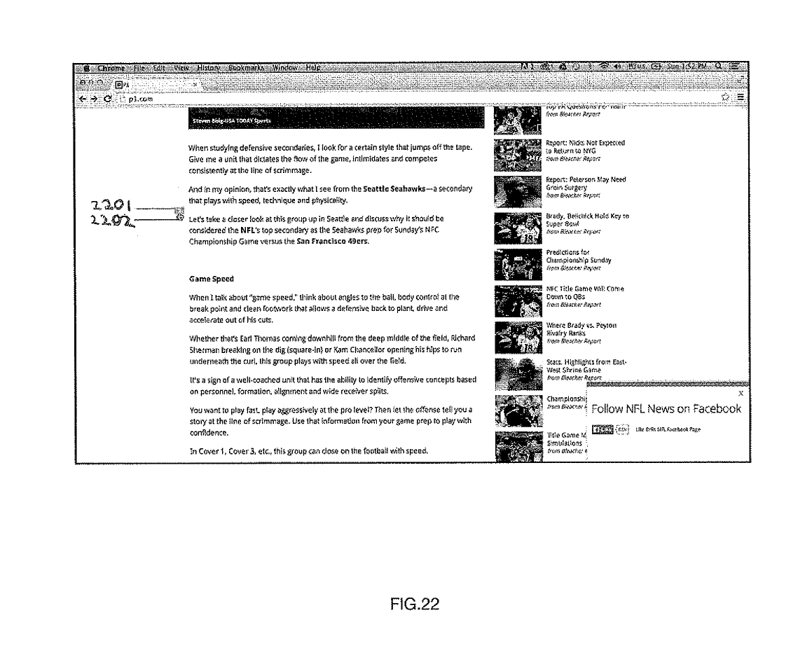

Moving to block 702, the system 120 receives a COMMENT BOX GET request with a BUBBLE_ID and USER_ID from the PYZ APP 132′. Receipt by the system 120 of the COMMENT BOX GET request indicates that a user has clicked on/activated, 2200 (FIG. 22) a comment icon, 2202 (FIG. 22) on the URL, for example, www.p1.com, to which the user has directed his browsing application (for the purposes of this explanation, the USER has clicked on an existing comment icon rather than a new comment icon). From block 702, the process moves to both blocks 704 and 712.

At block 704, the system 120 searches the USER BUBBLE VISITS table 134e-3 for existing entries (rows) with matching USER and BUBBLE IDs, to those IDs received in the COMMENT BOX GET request (at previous block 702). The process then moves to block 706 where the system 120 determines whether the user has previously visited (opened, or activated) the bubble, which was clicked on, and that caused the COMMENT BOX GET request to be sent by the PYZ APP 132′ to the system 120 (at previous block 702). For example, the system 120 searches the USER BUBBLE VISITS table 134e-3 for existing entries (or rows) with matching USER and BUBBLE IDs to those IDs that were received by the system 120 (at previous block 702).

If, at block 706, the system 120 determines that the user has previously opened the comment icon 2201 (previously opened, or activated, as represented by element 2202), the specific existing comment icon, 2200 of FIG. 22) (the determination is made based on whether the system 120 identifies entries in the USER BUBBLE VISITS table 134e-3 that contain matching USER and BUBBLE IDs to those received in the COMMENT BOX GET request), the process moves to block 708. At block 708 the system 120 increases the number in the VISITS_COUNT column of the row with the matching USER_ID and BUBBLE_ID by the integer value of “1”. From block 708 the process moves to block 1262 of FIG. 12B.

However, if, at bock 706, the system 120 determines that the user has not previously been to the BUBBLE whose ID was received in the COMMENT BOX GET request (at block 702), the process moves to block 710. At block 710 a new entry is created in the USER BUBBLE VISITS table 134e-3 containing the integer “1” in the VISITS_COUNT column. From block 710, the process moves to block 1252 of FIG. 12B.

Returning to block 702, the process, in addition to moving to block 704 as detailed above, moves to block 712. At block 712, the system 120 searches for and retrieves the entries in the COMMENT table 134d-1 with matching BUBBLE_IDs to the BUBBLE_ID received by the system 120 in the COMMENT BOX GET request (the system 120 retrieves entry(s) from the COMMENT table 134d-1 because the USER, at previous block 702, clicked on an existing comment icon, 2200 of FIG. 22, rather than a new comment icon). The process moves to block 714, where the system 120 identifies the aforementioned entries in the COMMENT table 134d-1, the system 120 sends the entries to the PYZ APP 132′ which subsequently stores that data in temporary memory. From block 714, the process moves to block 1922 (FIG. 19).

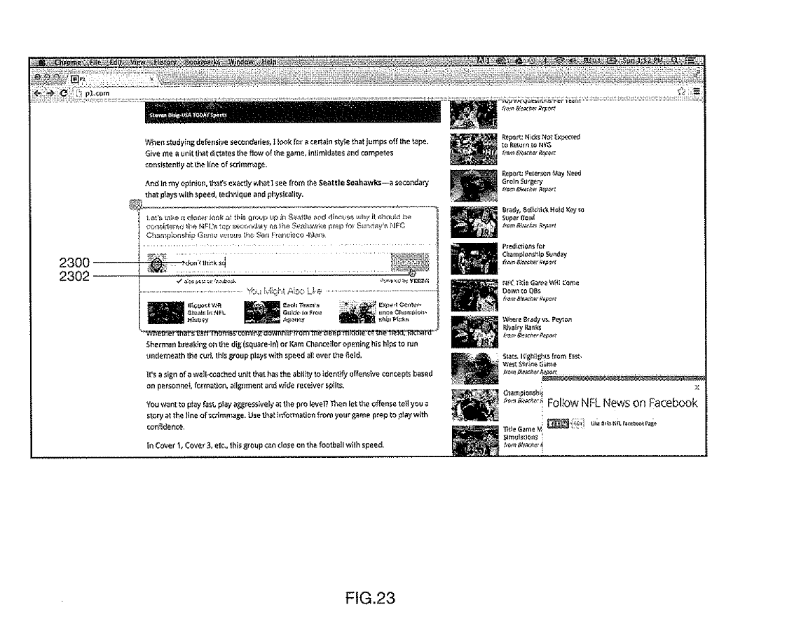

Attention is now directed to the flow diagram of FIG. 8, which shows the process, including subprocesses, for comment crawling. At the START block 800, a USER's actions are being monitored inside a comment box. At block 802 the system receives a COMMENT POST request from the PYZ APP 132′ through which USER actions are being monitored by the system 120. COMMENT POST requests are generated after the user enters text, 2300 (FIG. 23), and clicks on submit, button 2302, of FIG. 23. Once received by the system 120, the user generated content inside the COMMENT POST request is written to the COMMENTS table 134d-1(where it is given a unique ID) and the COMMENT TEXT table 134d-3 (where the comment's body, for example, its' text, is stored along with the unique ID given to it by the system 120). The process then moves to both blocks 804 and 808.

At block 804, the system 120 sends a SENTIMENT GET request to the sentiment analysis server 77. In the SENTIMENT GET request, the system 120 sends the comment's body, stored in COMMENT TEXT table 134d-3 (at block 802) and once received by the sentiment analysis server 77, the comment is crawled and parsed data is sent by the sentiment analysis server 77 to the system 120. Once the system 120 has received parsed data in response to its' SENTIMENT GET request from the sentiment analysis server 77, the process moves to block 806.

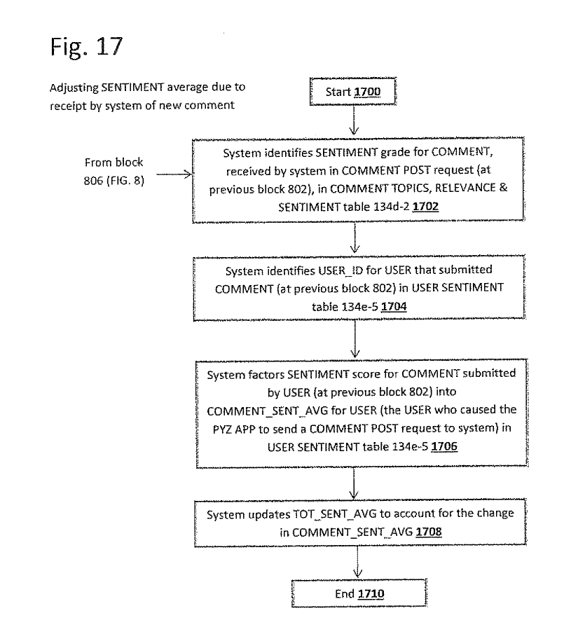

At block 806, the parsed data is analyzed and a sentiment grade is assigned to the comment in the COMMENT TOPICS, RELEVANCE & SENTIMENT table 134d-2. With the sentiment grade having been assigned to the comment received by the system 120 in the COMMENT POST request (at previous block 802), the process moves to block 1702 of FIG. 17 from where it continues.

From block 802, the process also moves to block 808. At block 808, the new comment text, taken from COMMENT TEXT table 134d-3, is sent in a KEYWORDS GET request to text analysis server 75. At the text analysis server 75, the comment is crawled such that natural language words and/or terms are obtained and sent as parsed data to the system 120.

The parsed data is received by the system 120 from the text analysis server 75 (the parsed data was sent to the system 120 in response to the KEYWORDS GET request of the system 120 at previous block 808) at block 810. Also at block 810 the parsed data is analyzed and keywords, search terms and other relevant phrases, words and terms are isolated in natural language.

Once isolated in natural language, the process moves to block 812, as the system 120 searches the TOPICS table 134b-1 for matching natural language words and terms to those that were received from the text analysis server 75 as parsed data (at previous block 810), and isolated in natural language (at previous block 812). The process moves from block 812 to block 814 where the system 120 determines whether there are matching topics inside the TOPICS table 134b-1 to those natural language terms that were identified and isolated in natural language at previous block 810.

The process of block 814 is performed by the web framework 133 by comparing the natural language words and/or terms that were isolated in natural language at block 810 to those that already exist in the TOPICS table 134b-1. Should it be determined that the natural language words or terms do not currently exist in the TOPICS table 134b-1, the process moves to block 816. At block 816 the natural language word or term, that was determined not to exist in the TOPICS table 134b-1, is added to the TOPICS table 134b-1 and assigned a unique ID (new ID). From block 816, the process moves to block 818.

However, if, at block 814, it was determined that there are matching topics in the TOPICS table 134b-1 to those that were isolated in natural language at block 810, the process moves directly to block 818.

At block 818, the natural language word or term for the comment is sent by the system 120, together with the natural language word(s) and/or term(s) for the URL and BUBBLE, on and in which the COMMENT was made, in a RELEVANCY GET request to the keyword and relevancy server 74.

From block 818, the process moves to block 820. At block 820 the keyword and relevancy server 74 performs an analysis on the relevancy of each natural language word or term of the COMMENT to the natural language words and/or terms of the BUBBLE and PAGE. Once the analysis is complete, the relevancy score for each natural language word and or term of the comment is sent, in response to the RELEVANCY GET request as parsed data, to the system 120.

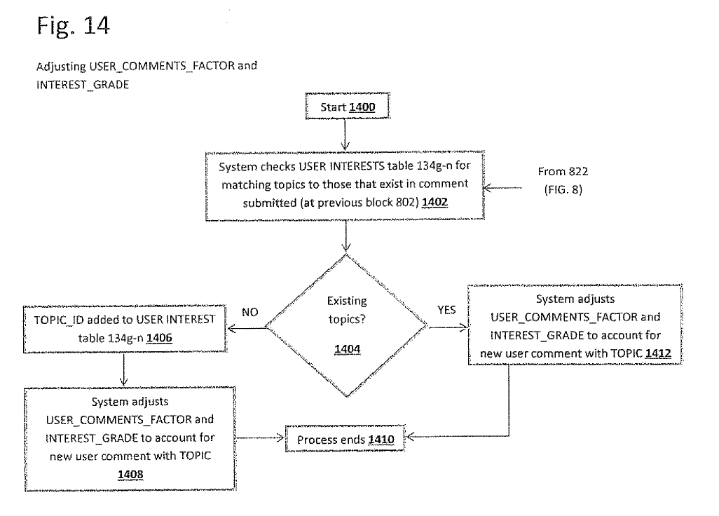

The process then moves to block 822 where the parsed data is analyzed by the system 120. The relevancy scores for each term, identified in the COMMENT are, for example, averaged. The result of the averaging of the relevancy scores of each natural language topic (e.g., in natural language terms) and the is saved in the COMMENT, TOPICS and RELEVANCY table 134d-2 as the relevancy score for the COMMENT. From block 822, the process continues by moving to block 1402 of FIG. 14.

FIG. 9 shows a process, including subprocesses, for making comments. At the start block 900 the user has created a profile with the system 120 and has directed his browser to a target web page, or URL, on which the client code associated with the PYZ APP 132′ is integrated and running.

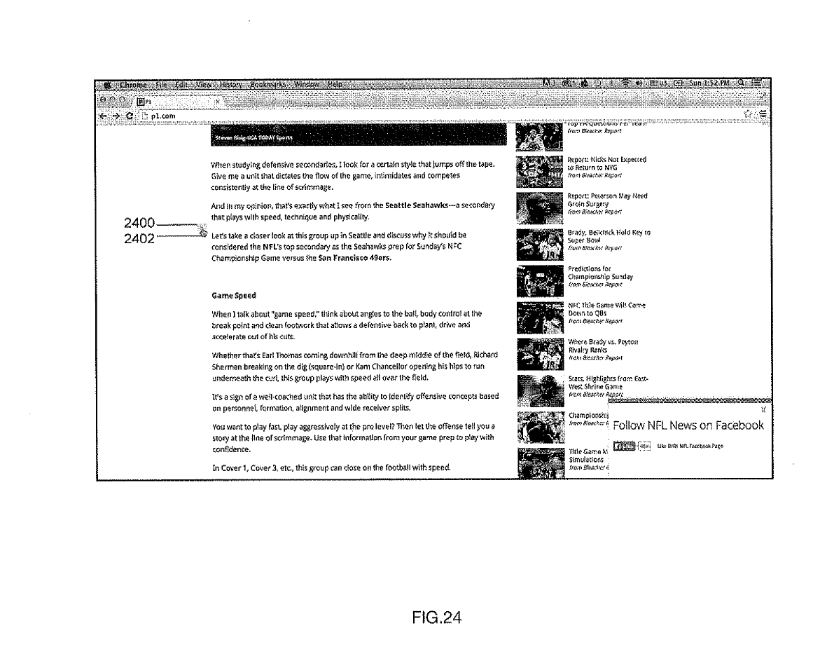

The process begins by moving to block 902. At block 902, the PYZ APP 132′ monitors the user's actions on a target web page, for example, with URL www.p1.com. From block 902 the process moves to block 904, where the PYZ APP 132′ sends the system 120 a COMMENT BOX GET request indicating that the user clicked on a new or existing comment icon, and the system 120 detects this action with the receipt of the COMMENT BOX GET request. The user's click on a new comment icon, 2400 (FIG. 24), is represented by the element 2402 of FIG. 24.

From block 904 the process moves to block 906 where the system 120 determines whether the user clicked on a new or existing comment icon. The system 120 makes the determination by checking if a BUBBLE_ID was received in the COMMENT BOX GET request that was sent by the PYZ APP 132′ to the system 120 (at previous block 904).

If, at block 906, the system 120 identifies a BUBBLE_ID in the COMMENT BOX GET request, the process moves to block 1922 of FIG. 19 and block 702 of FIG. 7. If, however, at block 906 the system 120 does not identify a BUBBLE_ID in the COMMENT BOX GET request, the process moves to block 1926 of FIG. 19.

The processes associated with FIG. 9 resumes with the user being presented with a comment box (on a web input, interactive and portal document) via his display monitor at either block 908 (after the system 120 determines that the user clicked on an existing comment icon, at previous block 906) or at block 916 (after the system 120 determines that the user clicked on a new comment icon, at block 906).

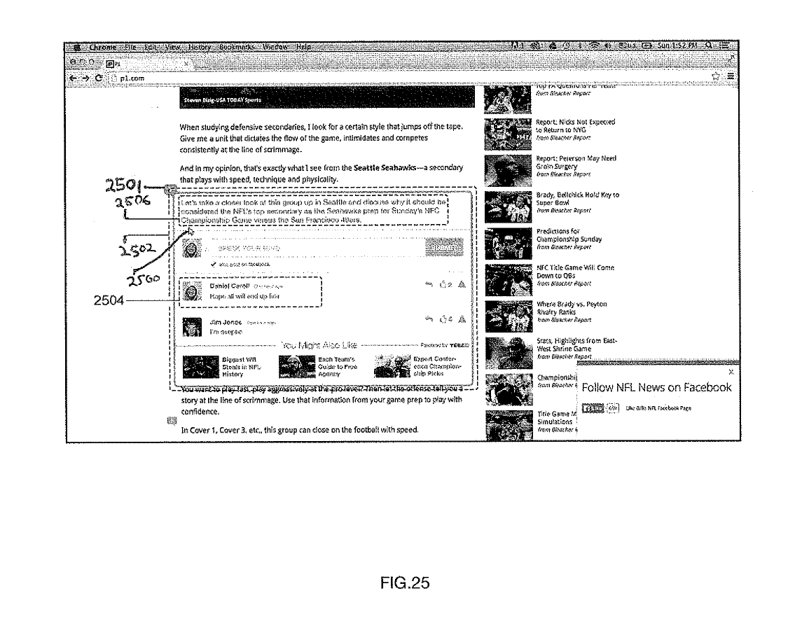

As shown in FIG. 25, should a USER have clicked (arrow 2500) on an existing comment icon, 2501, a comment box, 2502, is displayed on the display monitor of the user including, for example, previously made comments, broken line 2504, and the article text, represented by broken line box 2506, to which the comments refer.

From block 908 the process moves to block 910. At block 910, the system 120 monitors user actions for a click somewhere on the user's display monitor outside of the comment (input) box. If the system 120 determines that the user has clicked outside the comment (input) box presented to the user at block 908, the process returns to block 902 of FIG. 9.

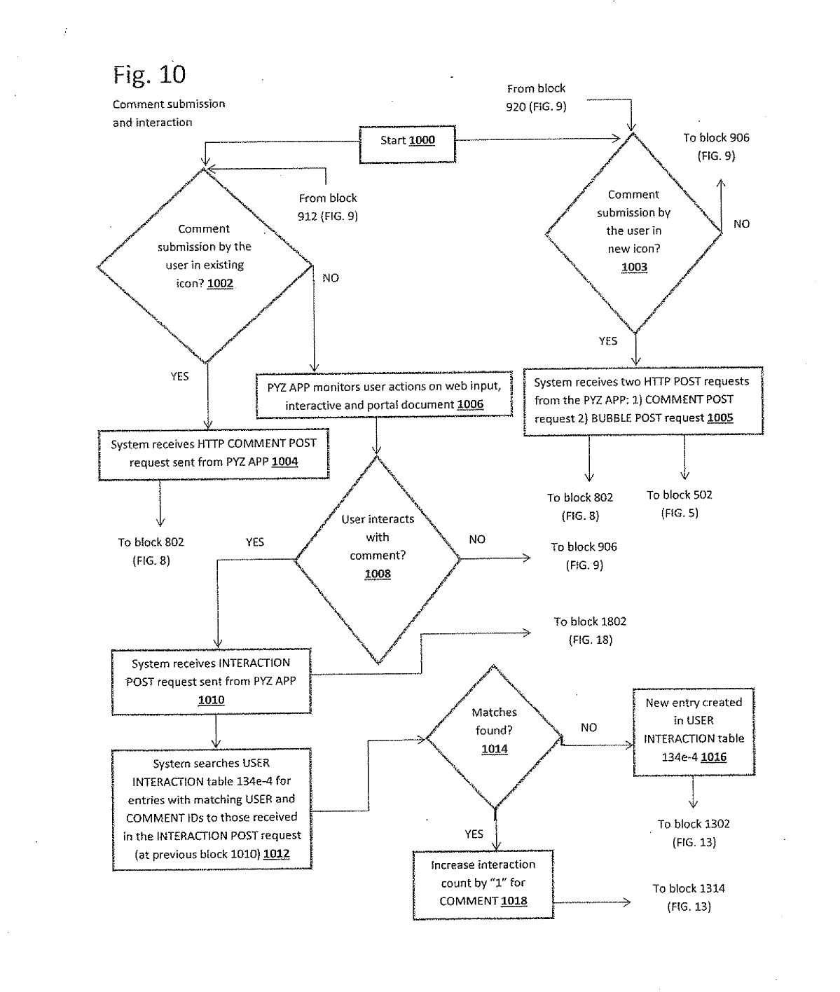

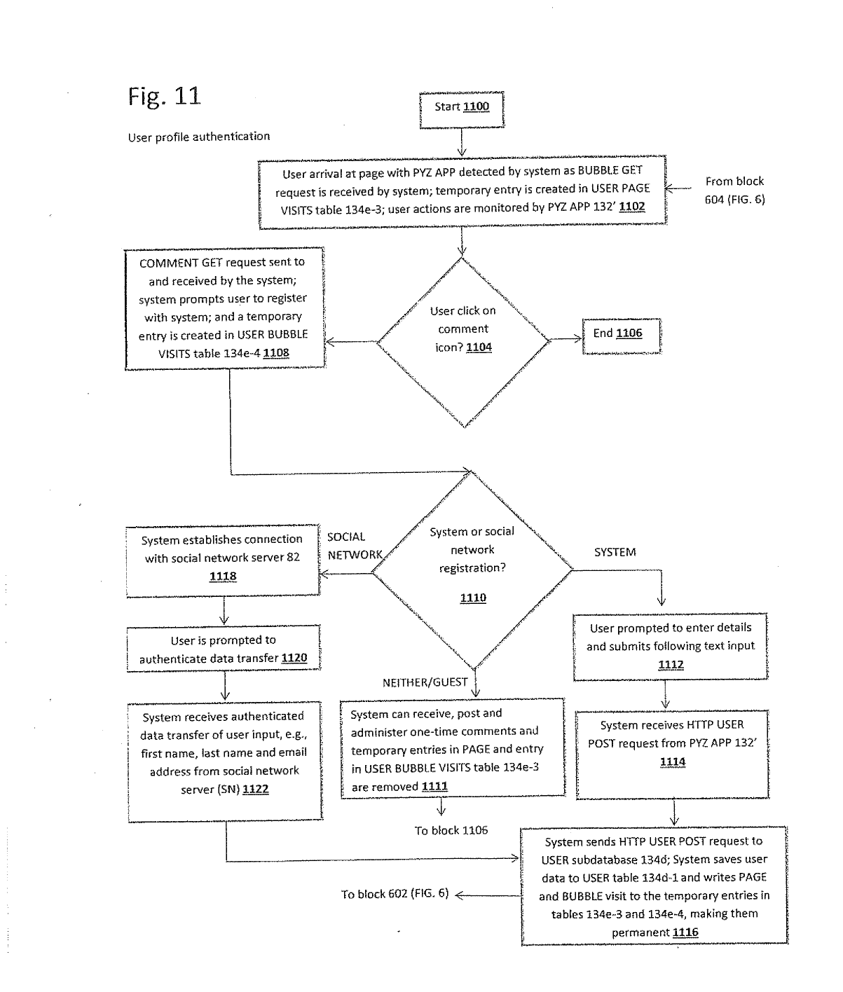

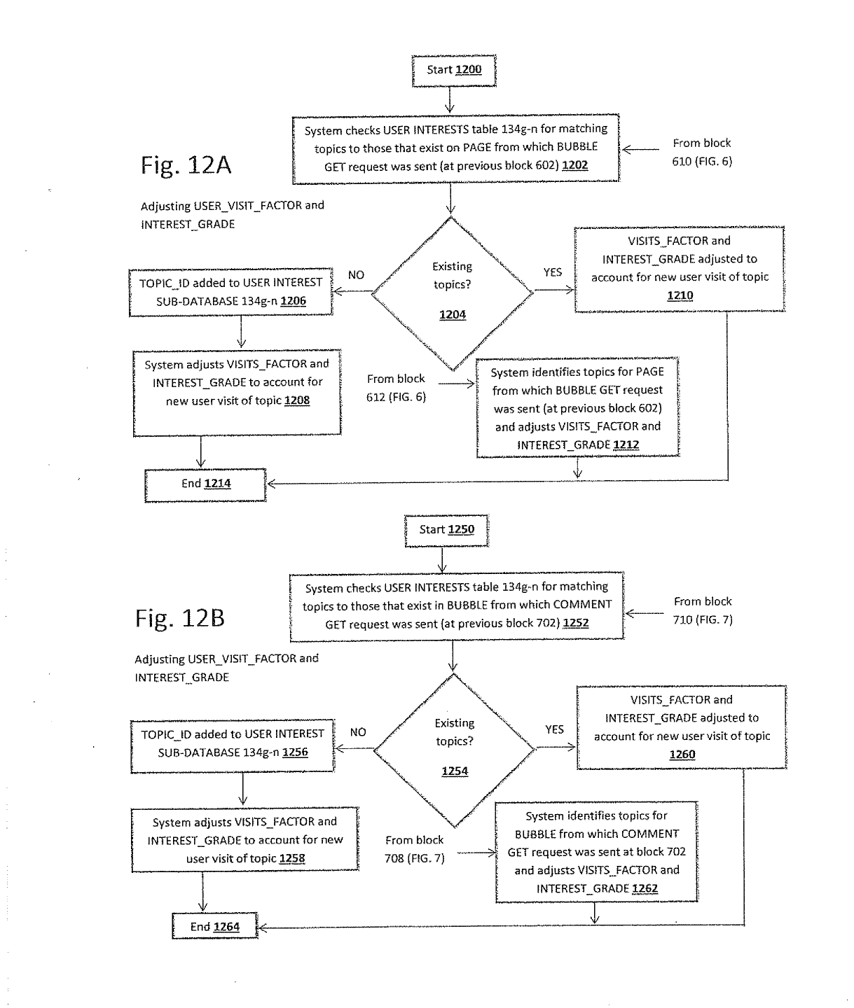

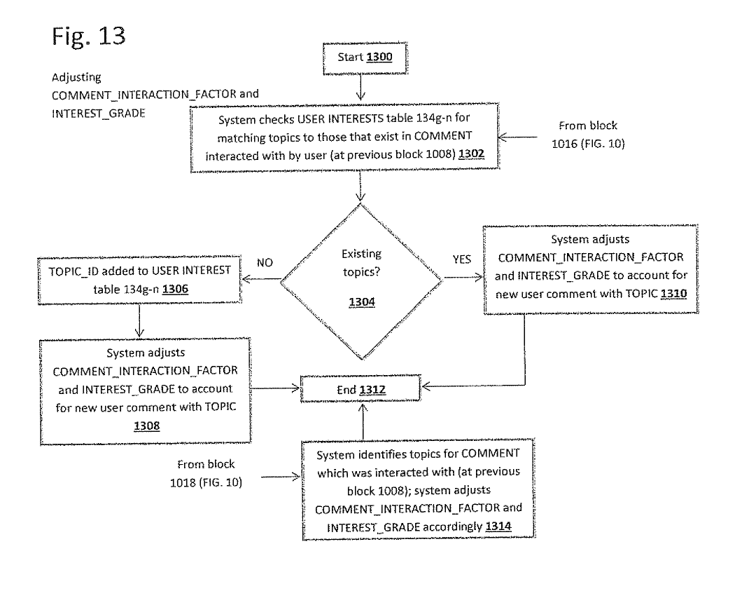

Alternately, if the system 120 does not detect a click outside the comment (input) box, 2506 (FIG. 25), the process moves to block 912. At block 912 the system 120 monitors for a connection termination, or timeout. If, at block 912, a timeout is not detected, the process moves to block 1002 (FIG. 10), where the PYZ APP 132′ continues to monitor user actions inside the comment box on the web input, interactive and portal document presented to the user (at block 908). However, if, at block 912, a timeout is detected, the process moves to block 914 where it ends.

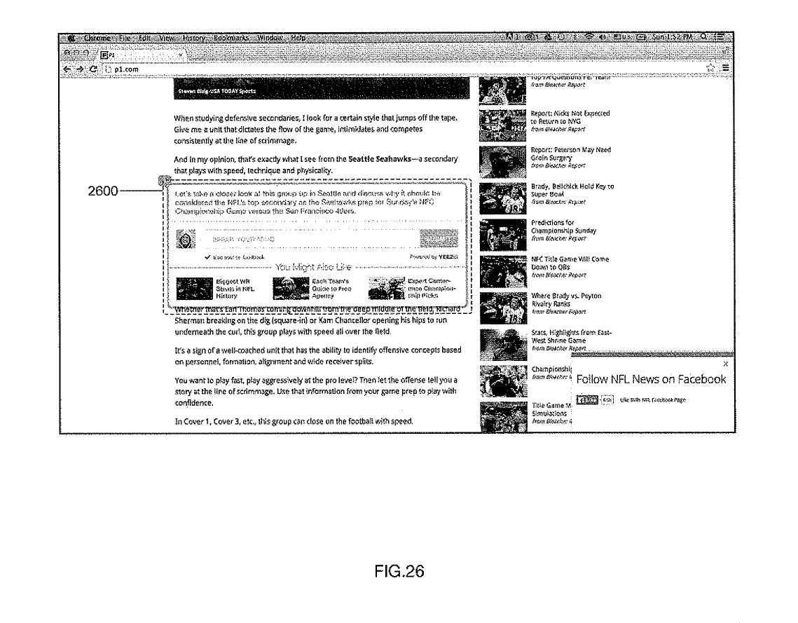

If, at block 906, it was determined that the user clicked on a new comment icon, the process resumes at block 916. If the user clicked on a new comment icon, he will be presented with a comment box (broken line box 2600 of FIG. 26—there are not any comments appearing inside the comment box due to the user having clicked on a new comment icon as opposed to an existing comment icon, where there would be comments appearing). At block 916, the user is presented with a comment (input) box. From block 916 the process moves to block 918, where the system 120 monitors user actions for a click somewhere on the user's display monitor outside of the comment (input) box. If the system 120 determines that the user has clicked outside of the comment box presented to the user at block 916, the process returns to block 902 of FIG. 9.

Alternately, if the system 120 does not detect a click outside the comment box, 2600 (FIG. 26), the process moves to block 920. At block 920, the system 120 monitors for a connection termination, or timeout. If, at block 920, a timeout is not detected, the process moves to block 1003 where the PYZ APP 132′ continues to monitor user actions inside the comment box on the web input, interactive and portal document presented to the user (at block 908). However, if, at block 920, a timeout is detected, the process moves to block 914 where it ends.

FIG. 10 shows a process, including subprocesses, for comment submission and interaction. At the START block 1000 of FIG. 10, USER actions are monitored on a web input, interactive and portal document by the PYZ APP 132′ (as detailed in FIG. 9). The process moves to block 1002 which is also arrived at from block 912 (FIG. 9). At block 1002 the system 120 monitors user actions inside a comment box generated by the user's click on an existing comment icon at previous block 906 (FIG. 9). The process also moves to block of 1003, which is also arrived at from block 920 (FIG. 9), where the system 120 monitors user actions inside a comment box generated by the user's click on a new comment icon at previous block 906 (FIG. 9).

If, at block 1003 the system 120 determines that the user submitted a comment (the system 120 makes this determination when it receives a COMMENT POST request), the process moves to block 1005. At block 1005, the system 120 receives an HTTP COMMENT POST request as well as an HTTP BUBBLE POST request from the PYZ APP 132′ (the system 120 also receives a BUBBLE POTS request due to the fact that the user clicked on a new comment icon). From block 1005 the process continues to block 802 (FIG. 8) where the processes associated with comment crawling are described, and to block 502 of FIG. 5 where the processes associated with BUBBLE storage and analysis are described. If, however, at block 1003 the system does not receive any HTTP POST requests the process moves to block 906 (FIG. 9)

If, at block 1002 the system 120 determines that the user submitted a comment, the process moves to block 1004. At block 1004, the system 120 receives an HTTP COMMENT POST request sent from the PYZ APP 132′ (the system 120 does not receive a BUBBLE POST request here because the user clicked on an existing comment icon). From block 1004 the process moves to block 802 (FIG. 8) where the processes associated with comment crawling are described.

However, if, at block 1002, it is determined that the user has not submitted a comment, the process moves to block 1006. At block 1006, the PYZ APP 132′ continues to monitor user actions on a web input, interactive and portal document for USER interactions. The USER action may be, for example, a LIKE, SHARE or FLAG of other USER's comments.

From block 1006, the process moves to block 1008. At block 1008, the PYZ APP 132′ determines whether the user interacts with a comment inside the comment box presented to the USER. For example, the system 120 determines whether the user “likes,” or “shares” or “flags” one of the comments, that appears in the comment box displayed to the user by the system 120 following the COMMENT BOX GET request of previous block 908 of FIG. 9 (COMMENT BOX GET requests and the actions necessary to generate such a request are elaborated on in FIG. 9).

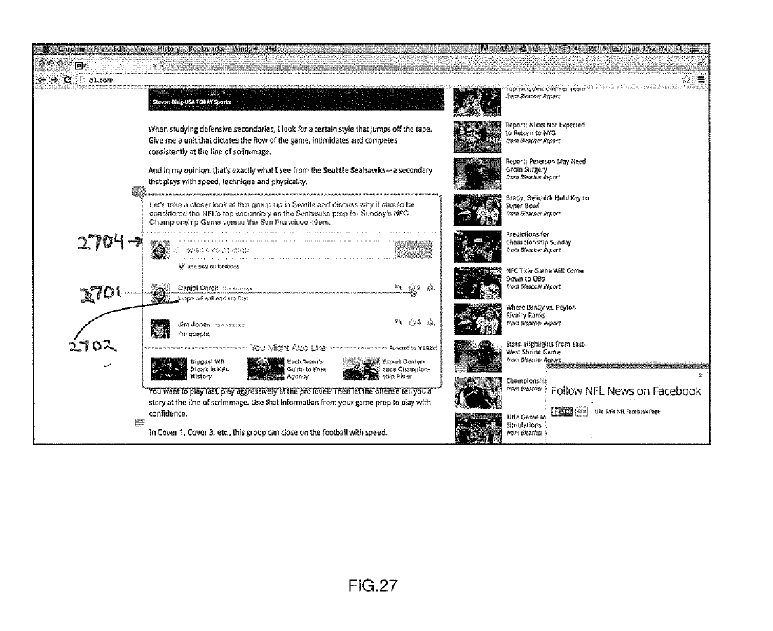

If, at block 1008, it is determined that the user has not interacted with a comment, the process moves to block 906 of FIG. 9 where it continues. If, however, at block 1008 it is determined that the user has interacted, represented by element 2701, with a comment 2703, in a comment box 2704, as is shown in FIG. 27, the process moves to block 1010 where the system 120 receives, from the PYZ APP 132′, an INTERACTION POST request (for purposes hereof, there is only one type of INTERACTION POST request. However, the system 120 is capable of handling various types of “interactions” and they do not necessarily need to be defined together as a single aggregate value in the database 134).

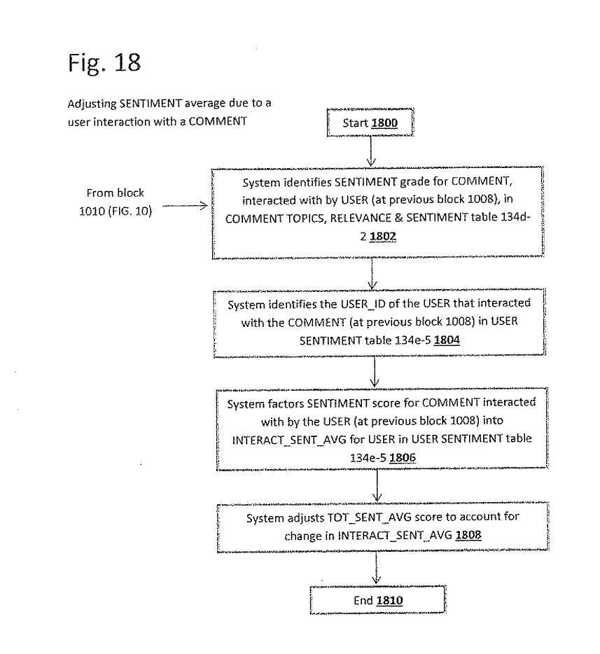

From block 1010 the process moves both to block 1012 and block 1802 of FIG. 18. At block 1012 the system 120 searches the USER INTERACTION table 134e-4 for entries with matching USER and COMMENT IDs to those received by the system 120 in the INTERACTION POST request at previous block 1010.

From block 1012, the process moves to block 1014 where the system 120 determines whether the USER has previously interacted with the COMMENT that the USER interacted with at block 1008. The system 120 makes this determination by identifying entries, in the USER INTERACTION table 134e-4, with matching USER_ID and COMMENT_IDs to those that were received by the system 120 from the PYZ APP 132′ in the INTERACTION POST request (at previous block 1010).

If it is determined that the user has not had a previous interaction with the comment (i.e., no matching entry was found), the process moves to block 1016, where a new entry is created in the USER INTERACTION table 134e-4. This new entry is a record of the USER's ID, the COMMENT's ID and a new INTERACTION_COUNT of “1”. From block 1016, the process moves to and resumes from block 1302 (FIG. 13).

However, if at block 1014, should the system 120 determine that the user has previously interacted with the comment (by identifying an entry in the USER INTERACTION table 134e-4 that has matching USER and COMMENT IDs to the IDs received by the system 120 in the INTERACTION POST request at previous block 1010), the process moves to block 1018. At block 1018, the field INTERACTION_COUNT, for the entry containing matching USER and COMMENT IDs, to the IDs received by the system 120 in the INTERACTION POST request of block 1010, is increased by the integer value “1”. From block 1018, the process moves to, and resumes from, block 1314 (FIG. 13).

The user authentication process, including subprocesses, of FIG. 11 begins at the START block 1100, before which the user must be operating his browser. The process moves to block 1102, where a user has navigated to a target web page, for example, www.p1.com, on which the PYZ APP 132′ client code is embedded and running. The user navigation to this target web page causes a BUBBLE GET request to be received by the system 120 after it having been sent by the PYZ APP 132′.

Also at block 1102, the system 120 has not identified a USER_ID in the BUBBLE GET request received. In response to the BUBBLE GET request that was received without a USER_ID (no user authentication identified), the system 120 temporarily creates a new entry in the USER PAGE VISITS table 134e-3, which will be deleted from the USER PAGE VISITS table 134e-3, unless the USER registers with the system 120.

The process then moves to block 1104, where the system 120 determines whether the user has clicked on, or otherwise activated, a comment icon. If, at block 1104 the system 120 determines that the user has not activated a comment icon, as the connection has been lost due to a browser redirect by the user, the process moves to block 1106 where it ends, and the temporary entry into the USER PAGE VISITS table 134e-3 is deleted.

If, however, at block 1104, the system 120 determines the user has clicked on a comment icon, the process moves to block 1108 where a COMMENT BOX GET request is sent to and received by the system 120. The USER is prompted by the system 120 to register, and a new, temporary, entry in the USER BUBBLE VISITS table 134e-4 is created (this temporary entry is deleted from the table USER BUBBLE VISITS 134e-4 unless the USER registers with the system 120).

From block 1108, the process moves to block 1110. At block 1110, the system 120 determines whether the USER registered with the system 120, through the social network server 82, the native system registration module 133b or neither. In the case of not having registered, the user has chosen to comment as a guest.

If, at block 1110 the system 120 determines that the USER has chosen to comment as a guest or has simply not chosen to register, the process moves to block 1111. At block 1111, the system 120 has the capability to receive, post and administer one-time comments. Also at block 1111, the temporary entries made in the USER PAGE VISITS table 134e-2 and the USER BUBBLE VISITS table 134e-3 are removed as the USER did not register with the system 120, choosing instead to remain anonymous. From block 1111, the process moves to block 1106 where it ends, and all remaining data entries regarding the USER's visit history (e.g., in USER PAGE VISITS table 134e-2 and USER BUBBLE VISITS table 134e-3) are deleted from the database 134.

If, at block 1110, the system 120 determines that the USER has chosen to register with the system 120 via the native system registration (module 133b), the process moves to block 1112 where the USER is prompted to enter his/her profile details. These details include, for example, first name, last name and email address. Once the user submits this information as input to the system 120, the process moves to block 1114.

At block 1114, the PYZ APP 132′ generates and sends a HTTP USER POST request to the system 120. Once the system 120 receives this HTTP USER POST request from the PYZ APP 132′, the process moves to block 1116 where the system 120 sends the data included in the USER POST request is sent to the USER SUB-DATABASE 134d where the information that was entered by the user (at previous block 1112) is stored in the USERS table 134d-1. Also at block 1116, the system 120 makes the temporary entries in USER PAGE VISITS table 134e-3 and USER BUBBLE VISITS table 134e-4, permanent by adding the new USER_ID to the entries. From block 1116 the process moves to block 602 of FIG. 6 where it resumes.

However, if, at block 1110, the user registers through social network (social network server 82, with the URL, www.sn.com) connect, the process moves to block 1118. At block 1118, the user's computer connects with the social network server 82 to create a data connection therewith in order to be able to perform an authenticated data transfer.

With the data connection established, the process moves to block 1120, where the user is prompted to authenticate a data transfer from the social network server 82 to the system 120. The process then moves to block 1122, where the user authenticates the data transfer, and the system 120 receives user data, for example, the new USER's first name, last name and email address. Having registered with the system 120, whether it be through the social network server 82 or through the native registration module 133b, the system 120 is subsequently able to track the user's movements across the network 15. From block 1122, the process moves to block 1116, from where the process continues.

The flow processes detailed in FIGS. 12-14 allow the system 120 to update, for example, in real-time, the values for VISITS_FACTOR, COMMENT_INTERACTION_FACTOR, USER_COMMENTS_FACTOR and INTEREST_GRADE in the USER's database 134g-n. These fields are continuously and cumulatively updated in accordance with user interactions with and inputs into the system 120 and allow the system to generate various types of information and content, such as personalized advertisements, content links and other similar media. The aggregate data of many USERs recorded herein, could provide insight into social trends, for example, buying trends, political persuasion, individual popularity as well as many others.

Turning to FIG. 12A, this process, including subprocesses, is designed to account for the real-time viewing, or visitation, by the user, of PAGES and the subsequent necessity to update the USER_VISITS_FACTOR and INTEREST_GRADE values of the USER INTERESTS table 134g-n. In order for this process to start, the USER must be navigating the Internet via his browsing application and interacting with the underlying content of pages on which the client code associated with the PYZ APP 132′ is embedded. This is detected by the system 120 prior to the START 1200.

The process moves from block 1200 to block 1202, where the USER INTERESTS table 134g-n is checked for matching topics to those that exist on the PAGE from which a BUBBLE GET request was sent (BUBBLE GET requests, and the handling thereof, are described starting from block 602 of FIG. 6).

From block 1202, the process moves to block 1204 where the system 120 determines whether the TOPIC(s), presently viewed by the user on the target web page (the target web page identified by the system via the PAGE_ID contained in the BUBBLE GET request), have been previously viewed by the user. The system 120 makes this determination by searching the USER's INTEREST table 134g-n for matching TOPIC IDs, to those that exist on the PAGE, to which the user directed his browsing application (for example, at previous block 602, the system 120 identifies the topics that exist on the URL by searching the PAGE TOPICS, RELEVANCE and SENTIMENT table 134a-2 for the TOPIC_IDs associated with the PAGE_ID of the URL to which the USER has directed his browsing application). If, at block 1204, the system 120 determines that the topic does not exist (signifying that the user has not previously visited a PAGE or BUBBLE, or made or interacted with a comment, with one or more of the TOPIC(s) from the PAGE to which the user directed his browsing application), the process moves to block 1206.

At block 1206, the TOPIC(s), that were determined, by the system 120, not to have not been in existence in the USER's INTEREST table 134g-n, e.g., not previously viewed/visited by the USER, are added to the USER's INTEREST table 134g-n. From block 1206, the process moves to block 1208, where the system 120 adjusts the VISITS_FACTOR and INTEREST_GRADE to account for the new TOPIC(s) added to the USER's INTEREST table 134g-n at block 1206. From block 1208 the process moves to block 1214, where the process ends.

However, if, at block 1204, the system 120 determines that the topics exist, the process moves to block 1210. A topic exists when the user has previously viewed the TOPIC(s) that exists on the PAGE (or has made or interacted with a comment containing the TOPIC(s)), to which the USER has directed his browsing application. At block 1210, the system 120 automatically adjusts the VISITS_FACTOR and INTEREST_GRADE to account for the USER's new TOPIC view(s)/visit(s). From block 1210 the process moves to block 1214, where the process ends.

FIG. 12A includes the process of block 1212, which is arrived at from block 612 (of FIG. 6). At block 1212, the TOPIC(s) from the PAGE, from which the BUBBLE GET request was sent (at block 602 of FIG. 6), are identified in the USER's INTERESTS table 134g-n. Additionally, the system 120 adjusts the VISITS_FACTOR and INTEREST_GRADE, to account for the new visit(s)/view(s) of those TOPIC(s). From block 1212, the process moves to block 1214, where the process ends.

Turning to FIG. 12B, this process, including subprocesses, is designed to account for the real-time viewing, or visitation, by the user, of BUBBLES and the subsequent necessity to update the VISITS_FACTOR and INTEREST_GRADE values of the USER INTERESTS table 134g-n. In order for the process to START, at block 1250, the USER is viewing or interacting with the underlying content of a web page on which the PYZ APP 132′ client code is embedded.

Once at the START block 1250, the process moves to block 1252. At block 1252, the USER INTERESTS table 134g-n is checked for matching topics to those that exist in the BUBBLE, whose activation, for example at previous block 702 (FIG. 7), caused the PYZ APP 132′ to send, to the system 120, a COMMENT BOX GET request (COMMENT BOX GET requests and the handling thereof are detailed above in FIG. 7).

From block 1252 the process moves to block 1254. At block 1254, the system 120 determines whether the TOPIC(s) that exist in the BUBBLE, viewed by the USER, with the USER's opening/activation of a comment icon (at previous block 702), have been previously viewed by the USER. This is performed as the USER INTERESTS table 134g-n is selected for matching TOPIC IDs, to those that exist in the BUBBLE (whose activation, or opening of, by the USER caused the PYZ APP 132′ to send a COMMENT BOX GET request at previous block 702).

If, at block 1254 the system 120 determines that the topic does not exist, the process moves to block 1256. The topic does not exist when the USER has not previously visited a PAGE or BUBBLE, or made or interacted with a COMMENT, with one or more of the TOPIC(s) from the BUBBLE that was accessed at previous block 702 of FIG. 7.

At block 1256, the TOPIC(s) that did not exist previously, e.g., have not been previously viewed/visited by the user, are added to the USER's INTEREST table 134g-n. From block 1256, the process moves to block 1258 where the system 120 adjusts the VISITS_FACTOR and INTEREST_GRADE to account for the new TOPIC(s) added to the USER's INTEREST table 134g-n (at previous block 1256). From block 1258, the process moves to block 1264, where the process ends.

However, if, at block 1254, the system 120 determines that the TOPIC(s) exist, the process moves to block 1260. A topic exists when the user has previously viewed, or made or interacted with a COMMENT which contains the TOPIC(s) from the BUBBLE that the user opened (at previous block 702). At block 1260, the system 120 adjusts VISITS_FACTOR and INTEREST_GRADE to account for the USER's new TOPIC view(s)/visit(s). From block 1260, the process moves to block 1264, where the process ends.

FIG. 12B includes the process of block 1262, which is arrived at from block 708 (of FIG. 7). At block 1262 the TOPIC(s) from the BUBBLE, which was opened by the user (at block 702 of FIG. 7), are identified in the USER's INTERESTS table 134g-n.

Additionally at block 1262, the system 120 adjusts the VISITS_FACTOR and INTEREST_GRADE, to account for the new visit(s)/view(s) of those TOPIC(s) by the USER.

The process, including subprocesses, detailed in FIG. 13 is designed to account for the real-time interaction of USERS with COMMENTS made by other USERS of the system 120 and the subsequent necessity to update the COMMENT_INTERACTION_FACTOR and INTEREST_GRADE values of the USER INTERESTS table 134g-n. The process begins at the START block 1300, where the USER is on (user's browser directed to) a target web page, on which the PYZ APP 132′ is embedded, and the user has opened a comment box thereon by activating a comment icon (this process is detailed in FIG. 7). The system 120 detects these actions and activities at the START block 1300.

The process moves to block 1302, where the system 120 checks the USER INTERESTS table 134g-n for TOPIC(s) which match those TOPIC(s) that exist in the COMMENT, that was interacted with by the user (at previous block 1008 of FIG. 10). Also, at block 1302, the process resumes from block 1016 of FIG. 10.

From block 1302, the process moves to block 1304. At block 1304, the system 120 determines whether the TOPIC(s) that exist in the COMMENT, interacted with by the USER with the user's reply to, like of, or share of a COMMENT (at previous block 1008 of FIG. 10), have been previously viewed by the USER by searching the USER INTERESTS table 134g-n for matching TOPIC IDs, to those that exist in the COMMENT (interacted with by the USER at previous block 1008).

This determination of the topic existing is made by searching the USER's INTEREST table 134g-n for matching TOPIC IDs, to those that exist in the COMMENT, that was interacted with by the USER (at previous block 1008). At block 1304, should the system 120 determine that the TOPIC(s) do not exist in the USER's INTEREST table 134g-n, the process moves to block 1306.

At block 1306, the TOPIC(s), which were identified by the text analysis server 75 (at previous block 808 of FIG. 8), of the COMMENT interacted with by the USER (at previous block 1008), but that do not currently exist in the USER's INTEREST table 134g-n, are added to the user's specific USER INTEREST table 134g-n. From block 1306 the process moves to block 1308, where the system 120 adjusts the COMMENT_INTERACTION_FACTOR and INTEREST_GRADE to account for the new TOPIC(s), which were added to the specific user's USER INTEREST table 134g-n (at block 1306) due to the user having interacted with a comment that contains a TOPIC which was not identified by the system 120 to exist in the USER's INTEREST table 134g-n. From block 1308, the process moves to block 1312, where the process ends.

Returning to block 1304, should the system 120 determine the TOPIC(s) exists, the process moves to block 1310. A topic exists when the COMMENT, interacted with by the USER (at previous block 1008), contain TOPIC(s) that exist in the USER's INTEREST table 134g-n. At block 1310, the system 120 adjusts the USER_INTERACTION_FACTOR and INTEREST_GRADE to account for the USER's new view of the TOPIC(s) (due to the USER having interacted with a comment at previous block 1008 of FIG. 10). From block 1310, the process moves to block 1312, where the process ends.

FIG. 13 includes the process performed at block 1314. Block 1314 is arrived at from block 1018 (of FIG. 10). At block 1314, the system 120 identifies the TOPIC(s) for the COMMENT, which was interacted with by the USER (at previous block 1008), and adjusts the COMMENT_INTERACTION_FACTOR and INTEREST_GRADE to account for the USER's new INTERACTION with those TOPIC(s).

Turning to FIG. 14, this process, including subprocesses, is designed to account for the real-time comment submissions by the USERs of the system 120 and the subsequent necessity to update the USER_COMMENTS_FACTOR and INTEREST_GRADE values for each user's USER INTERESTS table 134g-n. The process begins at the START block 1400, where the USER has submitted a COMMENT to the system 120. These actions and activities are detected by the system 120 and described in FIG. 8.

The process moves to block 1402 where the USER INTERESTS table 134g-n is checked for matching topics. Matching topics include those that exist in the COMMENT, which was previously submitted (at previous block 822 of FIG. 8) and processed by the system 120 in accordance with the flowchart of FIG. 8.

From block 1402, the process moves to block 1404, where the system 120 determines whether the TOPIC(s), submitted in the COMMENT by the USER (at previous block 802), exist in the USER's INTEREST table 134g-n. If, at block 1404, the system 120 determines that the TOPIC(s), submitted by the USER in the COMMENT, (at previous block 802 of FIG. 8), do not exist in the USER INTEREST table 134g-n (for the designated user), the process moves to block 1406.

At block 1406, the TOPIC(s), each with a unique TOPIC_ID, which do not yet exist in the USER's INTEREST table 134g-n, but exist in the COMMENT submitted by the USER (at previous block 803), are added to the USER's INTEREST table 134g-n. From block 1406, the process moves to block 1408.

At block 1408, the system 120 adjusts the USER_COMMENTS_FACTOR and INTEREST_GRADE to account for the new TOPIC(s) added to the USER's INTEREST table 134g-n at block 1406 (due to the USER's submission of a COMMENT, at block 802, with TOPIC(s) that did not yet exist in the USER INTERESTS table 134g-n). From block 1408, the process moves to block 1410, where the process ends.

Returning to block 1404, should the system 120 determine the TOPIC(s) in the COMMENT, submitted by the USER and received by the system 120 in a COMMENT POST request (at previous block 802), exist in the USER INTERESTS table 134g-n, the process moves to block 1412. At block 1412, the system 120 adjusts the USER_COMMENTS_FACTOR and INTEREST_GRADE to account for the new TOPIC(s) submitted by the USER in his COMMENT and received by the system 120 in a COMMENT POST request (at previous block 802). From block 1412 the process moves to block 1410, where the process ends.

The processes, including subprocesses, associated with FIGS. 15-18 detail the system 120 updating, for example, in real-time, the values of the PAGE_SENTIMENT_AVG, BUBBLE_SENTIMENT_AVG, COMMENT_SENTIMENT_AVG, INTERACT_SENTIMENT_AVG and TOTAL_SENTIMENT_AVG fields in the USER SENTIMENT table 134e-5. These fields are continuously and cumulatively updated in accordance with user interactions with the system 120. The aggregate data of many USERs recorded herein, could provide insight into social trends, for example, buying trends, political persuasion, individual popularity as well as many others.

FIG. 15 shows a process, including subprocesses, for adjusting sentiment average resulting from a page visit. The process of FIG. 15 begins at the START block 1500, before which the user has gone through the steps associated with FIG. 6 and is, at least, signed in and registered with the system. The system 120 has detected these actions and has carried out any processes necessary in conjunction therewith.

The process then moves from the START block 1500 to block 1502, where the SENTIMENT grade for the PAGE from which the BUBBLE GET request was sent (at previous block 602), is identified. The system 120 identifies the SENTIMENT grade for the PAGE by accessing the PAGE TOPICS, RELEVANCE and SENTIMENT table 134a-2 and looking for the PAGE_ID that was received by the system 120 in the BUBBLE GET request (at previous block 602). Also at block 1502, the process from block 604 of FIG. 6 resumes.

Once the SENTIMENT grade for the PAGE is identified, the process moves to block 1504, where the USER_ID, for the USER that caused the PYZ APP 132′ to send the BUBBLE GET request (at previous block 602) to the system 120, is identified in the USER SENTIMENT table 134e-5. The system 120 locates the USER_ID by instructing the web framework 133 to search for the same USER_ID that was received by the system 120 in the BUBBLE GET request (at previous block 602).

With the system 120 having identified the SENTIMENT grade for the PAGE, in PAGE TOPICS, RELEVANCE & SENTIMENT table 134a-2, and having located the row in the USER SENTIMENT table 134e-5, containing the USER_ID of the USER who generated the BUBBLE GET request (at block 602), the process moves to block 1506.

At block 1506, the system 120 instructs the web framework 133 to adjust the PAGE_SENTIMENT_AVG for the USER who directed his browsing application to the PAGE which caused the PYZ APP 132′ to send a BUBBLE GET request to the system 120 at block 602 (the number in the PAGE_SENTIMENT column of the USER SENTIMENT table 134e-5 is the average sentiment score for the PAGES visited by each USER).

From block 1506, the process moves to block 1508. At block 1508, the web framework 133 automatically updates the OVERALL_SENTIMENT score for the USER to account for the change in his PAGE_SENTIMENT_AVG that was previously adjusted (at block 1506), due to the user having visited a PAGE on which the PYZ APP 132′ client code is embedded and running (the numbers in the TOTAL_SENTIMENT_AVG column of the USER SENTIMENT table 134e-5 are an average of the four average sentiment scores also listed in the USER SENTIMENT table 134e-5-PAGE_SENTIMENT_AVG, BUBBLE_SENTIMENT_AVG, COMMENT_SENTIMENT_AVG, and INTERACT_SENTIMENT_AVG). From block 1508, the process moves to block 1510, where it ends.

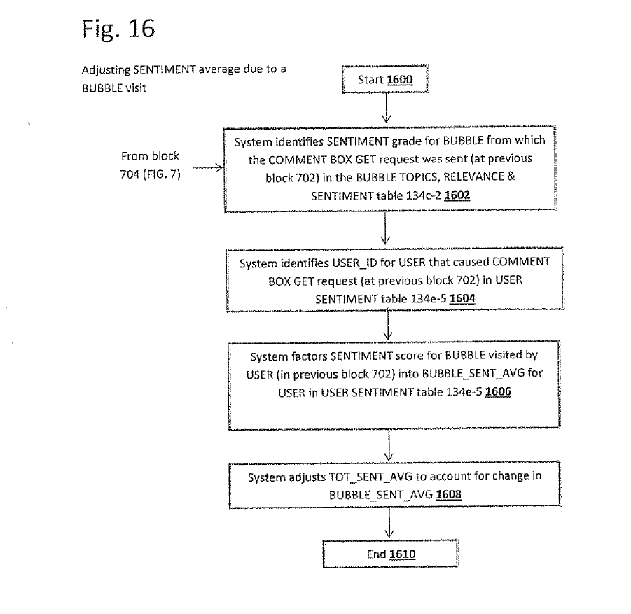

FIG. 16 is a process, including subprocesses, for adjusting sentiment average due to a BUBBLE visit. The process begins at the START block 1600, where the user has activated a comment icon on a target web page, for example, www.p1.com. This activation is detected by the system 120, having received a COMMENT BOX GET request.

The process moves to block 1602, where the SENTIMENT grade for the BUBBLE, due to whose activation has caused a COMMENT BOX GET request, is sent by the PYZ APP 132′ to the system 120 (at previous block 702), is identified. The system 120 identifies the SENTIMENT grade for the BUBBLE by accessing the BUBBLE TOPICS, RELEVANCE & SENTIMENT table 134c-2, and searching for the BUBBLE_ID, that was received by the system 120 in the COMMENT BOX GET request (at previous block 702).

At block 1602, the process also resumes from block 704 of FIG. 7

Once the SENTIMENT grade for the BUBBLE is identified, the process moves to block 1604. At block 1604, the system 120 identifies the USER_ID, for the USER that caused the PYZ APP 132′ to send the COMMENT BOX GET request (at previous block 702), in the USER SENTIMENT table 134e-5. The system 120 locates the USER_ID in the USER SENTIMENT table 134e-5 by instructing the web framework 133 to search for the same USER_ID received by the system 120 in the COMMENT BOX GET request (at previous block 702).

Once the system 120 has identified the SENTIMENT grade for the BUBBLE (the BUBBLE which was activated by the USER at block 702) in BUBBLE TOPICS, RELEVANCE & SENTIMENT table 134c-2, and has located the row in the USER SENTIMENT table 134e-5 containing the USER_ID of the USER who activated the BUBBLE at block 702, the process moves to block 1606.

At block 1606, the system 120 factors the SENTIMENT score for the BUBBLE, visited by the USER (at previous block 702), into the BUBBLE_SENTIMENT_AVG in the USER SENTIMENT table 134e-5. This accounts for the USER's activation, at block 702, of a comment icon, which caused the PYZ APP 132′ to send a COMMENT BOX GET request to the system 120.

From block 1606, the process moves to block 1608. At block 1608, the web framework 133 automatically updates and adjusts the TOTAL_SENTIMENT_AVG to account for the change in the value of the USER's BUBBLE_SENTIMENT_AVG (which occurred at previous block 1606). The process then moves to block 1610, where it ends.

FIG. 17 shows a process, including subprocesses, for adjusting sentiment average resulting from receipt by the system 120 of a new comment. The process begins at START block 1700 where, previously, a USER has submitted a comment, and the system 120 has received a COMMENT POST request. The system 120 detects these actions and the process moves to block 1702.

At block 1702, the system 120 identifies the SENTIMENT grade for the COMMENT. This is done as the system 120 instructs the web framework 133 to access and search the COMMENT TOPICS, RELEVANCE and SENTIMENT table 134d-2 for the COMMENT_ID of the COMMENT that the system 120 received in the COMMENT POST request (at previous block 804). Also at block 1702, the process resumes from block 806 of FIG. 8.

Once the SENTIMENT grade for the COMMENT is identified, the process moves to block 1704. At block 1704, the system 120 identifies the USER_ID, for the USER that submitted the COMMENT via a COMMENT POST request (sent to the system 120 at previous block 802), in the USER SENTIMENT table 134e-5. The system 120 also locates the USER_ID in the USER SENTIMENT table 134e-5 by instructing the web framework 133 to search for the USER_ID received by the system 120 in the COMMENT POST request (at previous block 702) at block 1704.

Once the system 120 has identified the SENTIMENT grade for the COMMENT (which was sent in a COMMENT POST request by the PYZ APP 132′ to the system 120 at block 802) in COMMENT TOPICS, RELEVANCE and SENTIMENT table 134d-2 and the row in the USER SENTIMENT table 134e-5 containing the USER_ID of the USER (who submitted a comment at previous block 802), the process moves to block 1706. At block 1706, the system 120 automatically adjusts the COMMENT_SENTIMENT_AVG field of the entry containing the USER_ID of the USER who caused the PYZ APP 132′ to send a COMMENT POST request to the system 120 (at block previous 802), to account for the SENTIMENT_SCORE of the new comment.

From block 1706, the process moves to block 1708. At block 1708, the web framework 133 automatically updates the TOTAL_SENTIMENT_AVG score for the USER to account for the change in the user's COMMENT_SENTIMENT_AVG (which occurred at previous block 1706). This COMMENT_SENTIMENT_AVG value was adjusted (at block 1706), due to the USER having submitted a new COMMENT, as detected by the system 120. From block 1708, the process then moves to block 1710, where it ends.

FIG. 18 shows a process, including subprocesses, for adjusting sentiment average resulting user interaction with a comment. The process begins at block 1800 where, or previously, the USER caused the PYZ APP 132′ to send an INTERACTION POST request to the system 120. With the system having detected the INTERACTION POST request, via a receipt thereof, the process is at the START block 1800. The process then moves from the START block 1800 to block 1802.

At block 1802, the SENTIMENT grade for the COMMENT interacted with by the USER (for example, at block 1008) is identified. The system 120 identifies the SENTIMENT grade for the COMMENT by accessing the COMMENT TOPICS, RELEVANCE and SENTIMENT table 134d-2 and searching for the COMMENT_ID of the COMMENT received in the INTERACTION POST request by the system 120 (at previous block 1008). Also at block 1802, the process resumes from block 1010 of FIG. 10.

With the SENTIMENT grade for the COMMENT identified, the process moves to block 1804. At block 1804, the USER_ID, of the USER that caused the PYZ APP 132′ to send an INTERACTION POST request to the system 120 (at previous block 1008), is identified by the system 120 in the USER SENTIMENT table 134e-5. The system 120 locates the USER_ID in the USER SENTIMENT table 134e-5 by instructing the web framework 133 to search for the USER_ID received by the system 120, in the INTERACTION POST request (at block 1008), in the USER SENTIMENT table 134e-5.

Once the system 120 has identified the SENTIMENT grade for the COMMENT (whose COMMENT_ID was sent in the INTERACTION POST request by the PYZ APP 132′ to the system 120 at block 1008) in COMMENT TOPICS, RELEVANCE and SENTIMENT table 134d-2, and has located the row in the USER SENTIMENT table 134e-5 containing the USER_ID of the USER (the USER whose interaction with a COMMENT caused the PYZ APP 132′ to send an INTERACTION POST request to the system 120 at previous block 1008), the process moves from block 1804 to block 1806.

At block 1806, the system 120 factors the SENTIMENT score for the COMMENT (that was interacted with by the USER at block 1008) into the INTERACT_SENTIMENT_AVG for the USER (whose interaction caused the receipt by the system 120 of an INTERACTION POST request) in USER SENTIMENT table 134e-5.

From block 1806, the process moves to block 1808. At block 1808, the web framework 133 automatically updates the TOTAL_SENTIMENT_SCORE for the USER, to account for the change in his INTERACT_SENTIMENT_AVG (of table 134e-5), that was adjusted previously (at block 1806). This previous adjustment was due to the USER having interacted with a COMMENT made previously by a user of the system 120. From block 1808 the process moves to block 1810 where it ends.

FIG. 19 shows a process, including subprocesses, for retrieval and display of relevant content, for example, information such as advertisements. Before the start of the process at block 1900 a USER causes the PYZ APP 132′ to send a BUBBLE GET request to the system 120. Once the system 120 receives the BUBBLE GET request, the system 120 initiates the process associated with FIG. 19.

From the START block 1900, the process moves to block 1902. At block 1902, the system 120 identifies the USER_ID of the USER who caused the system 120 to receive a BUBBLE GET request (prior to the start of the process, block 1900). The system 120 retrieves INTEREST_GRADES for each topic in the USER INTERESTS table 134g-n and his/her TOT_SENT_AVG value from the USER SENTIMENT table 134e-5.

Also at block 1902, the system 120 uses the PAGE_ID, received in the BUBBLE GET request, to retrieve information regarding the existing BUBBLES on the URL (from BUBBLES table 134c-1, if any BUBBLE(s) exist) and the TOPICS of the PAGE from PAGE TOPICS, RELEVANCE and SENTIMENT table 134a-2. The system 120 also searches for existing BUBBLES for PAGE_IDs and retrieves data associated with the PAGE_ID.

From block 1902 the process moves to blocks 1904, 1908 and 1912. At block 1904, the TOPICS for the PAGE from which the BUBBLE GET request was sent, are sent by the system 120 to the content recommendation engine 140, where relevant ads for the PAGE are identified from within the ADVERTISTER LISTING table 134f-3.

From block 1904 the process moves to block 1906 where the content recommendation engine 140 obtains relevant ads, according to the PAGE's topics and predefined settings of the system 120, for example, yield, CTR or relevancy. Once ads (e.g., content recommendations or information links) are generated, this data, regarding the chosen ads, are sent to the PYZ APP 132′ which stores the data in its temporary memory. From block 1906 the process moves to block 1920.

From block 1902 the process also moves to block 1908 where the USER's TOPIC_INTEREST_GRADES and TOT_SENT_AVG scores (of the USER who caused a BUBBLE GET request to be sent to the system 120, and which data is stored in USER INTERESTS table 134g-n and USER SENTIMENT table 134e-5, respectively) are sent to the content recommendation engine 140.

From block 1908, the process moves to block 1910. At block 1910 the content recommendation engine 140 obtains relevant ads, in accordance with previously compiled data about the USER, for example, the USER's TOPIC_INTEREST_GRADES and TOT_SENT_AVG, and predefined settings of the system 120, for example, according to yield, CTR (click-through-rate) or relevancy. This data, regarding the chosen ads, is then sent to the PYZ APP 132′. The PYZ APP 132′ stores the data in its temporary memory. From block 1910, the process moves to block 1920.

From block 1902, the process also moves to block 1912. At block 1912, the system 120 attempts to identify BUBBLES for the URL with PAGE_ID received in the BUBBLE GET request. This identification occurs when the PAGE_ID, received in the BUBBLE GET request, is used by the system 120 to search the BUBBLES table 134c-1 for matches. If, at block 1912, no BUBBLES are found for the PAGE_ID that is being used to search the table 134c-1, the process moves to block 1914, where it ends.

However, if, at block 1912, the system 120 identifies BUBBLE, e.g., entries in the BUBBLES table 134c-1 that contain matching PAGE_IDs, to the PAGE_ID that was received by the system in a BUBBLE GET request, the process moves to block 1916. At block 1916, the system 120 sends the data stored in the database 134 regarding the BUBBLE_ID(s) identified by the system 120 to exist on the URL from which the BUBBLE GET request was sent to the content recommendation engine 140. At the content recommendation engine 140, relevant ads (e.g., content recommendations or information links) for the BUBBLE are identified from within the ADVERTISER LISTING table 134f-3.

From block 1916 the process moves to block 1918. At block 1918, the content recommendation engine 140 obtains relevant ads, in accordance with the BUBBLE's TOPICS and predefined settings of the system 120, for example, according to yield, CTR (click-through-rate) or relevancy. Once identified by the system 120, the data regarding the chosen ads is sent to the PYZ APP 132′ which stores the data in its temporary memory. From block 1918 the process moves to block 1920.

At, or prior to, block 1920, arrived at from block 1906, 1910, 1918 and block 702 (FIG. 7), a user has clicked on a comment icon, causing the system 120 to receive a COMMENT BOX GET request. At block 1920, the system 120 determines whether the BUBBLE, clicked on by a user prior to block 1920, is a new or existing bubble, e.g., comment icon.

The system 120 makes this determination by checking if a BUBBLE_ID is received in the COMMENT BOX GET request. If an existing BUBBLE_ID is received in the COMMENT BOX GET request, the process moves to block 1922. At block 1922, initially, the PYZ APP 132′ selects content, for example information such as advertisements (ads), for example, in real-time and in accordance with predefined settings of the system 120, the BUBBLE's characteristics, and USER's attributes to display in the comment box. The system 120 selects the content, e.g., ads, from the temporary memory of the PYZ APP 132′ according to the characteristics of the existing BUBBLE, USER attributes and predefined system 120 setting. Also at block 1922, the process resumes from block 714 of FIG. 7 and block 906 of FIG. 9.

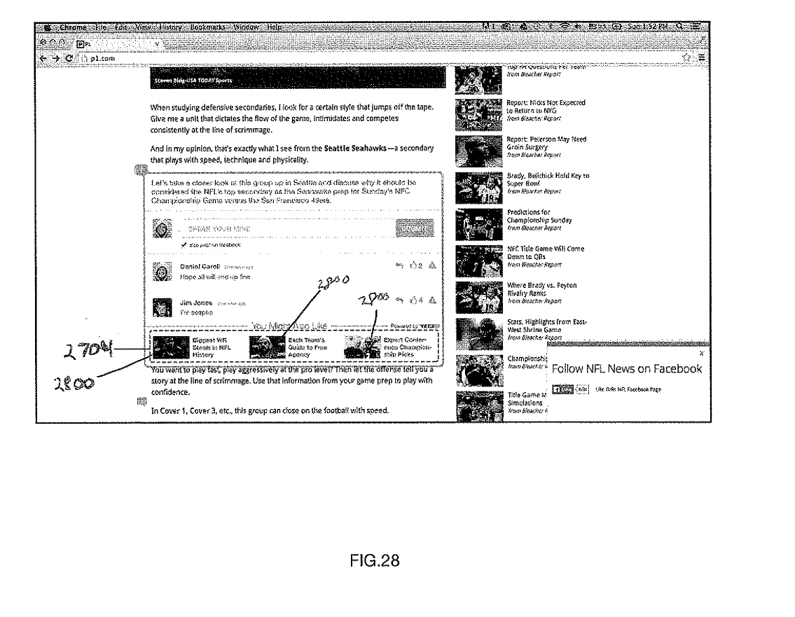

From block 1922 the process moves to block 1924 where the system 120 displays a comment box 2704 (FIG. 27) on the display monitor of the USER. The comment box, 2704, is displayed, for example, with the relevant links 2800 (FIG. 28). The links 2800 include and textual and visual content decided upon by the PYZ APP 132′ at block 1922. The links, 2800 of FIG. 28, may relate to the URL's content, the existing BUBBLE, USER attributes and predefined setting of the system 120. From block 1924 the process moves to block 908 (FIG. 9).

If, however, at block 1920, the system 120 does not receive an indication of a user click on an existing comment icon, the process moves to block 1926 (in this case, a BUBBLE_ID is only generated if the USER submits a comment—in accordance with the flow diagram of FIG. 5). At block 1926, the PYZ APP 132′ selects content, e.g., ads, content recommendations or information links, for example, in real-time and in accordance with predefined settings of the system 120, the PAGE's characteristics, and USER attributes to display in the comment box.

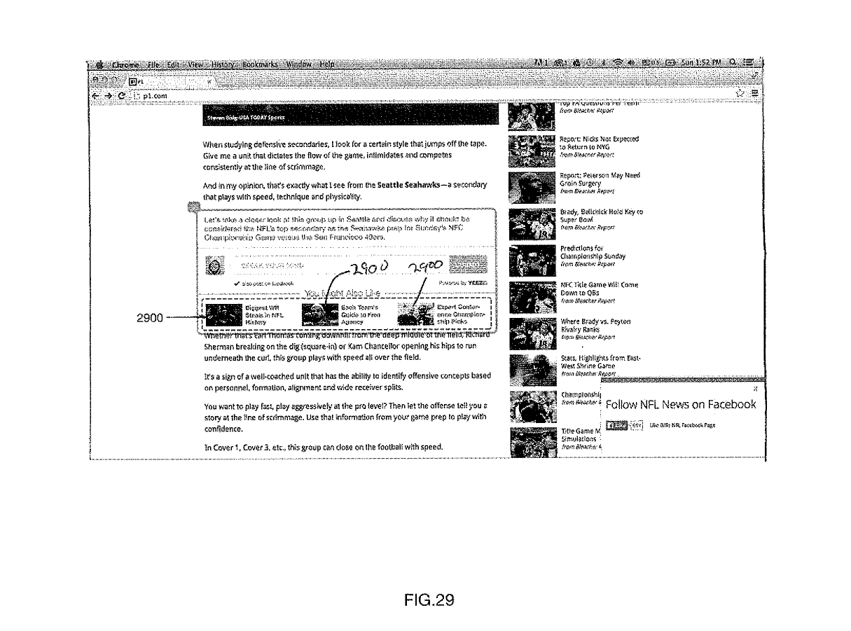

From block 1926 the process moves to block 1928. At block 1928, the system 120 displays a comment box on the display monitor of the USER with the relevant links 2900 (FIG. 29). The textual and visual content decided upon by the PYZ APP 132′, at block 1926, relates to the URL, on which the user is found, USER attributes and predefined settings of the system 120. From block 1928 the process moves to block 916 (FIG. 9), from where it resumes.

For example, any content displayed by the system 120, via the process of FIG. 19, as described above, to users through a comment box on the web page of Publisher1 (P1), represented by server 50a, could originate from Publisher2 (P2), represented by server 50b and the content would be considered native content. This is because these servers 50a and 50b are part of a network 53. As a result of the network 53, content from the P1 server 50a and displayed on the P2 server 50b, or vice versa, is considered native content to both publishers P1 and P2.

In alternative embodiments, the system 120 may be programmed to aggregate and map comments made across specific web sites and web pages. As a result, site or system administrators can track popular content, controversial content or actors, and successful or problematic advertising, information providing and/or marketing campaigns. Additionally, the system 120 can be programmed to follow each comment made, such that it is tagged, so as to be stored as a comment string, in a sub-database of the database 134, so as to track trends, memes, language development, mass opinions and phrase coinage while providing a tool for the public to monitor participation in public conversations. These comment strings can also be broken down further so as to allow for cross referencing with metadata which can be used to generate content links, to connect like-minded commenters, and or to make forecasts regarding the quality of comments on past, current and/or future web documents associated with the system 120.

Also, comments such as those of the same or similar subject matter, the same author, or other parameter, from the same or different web documents, associated with the same or different web pages or web sites, can be stored in subdatabases of the database 134. The aforementioned subdatabases may be searchable by users of the system 120 by accessing the home server 130 at www.homeserver.com, or through an available search engine, such as Google®, Yahoo® and the like. These sub databases are to provide end users with information associated with web sites, web pages, web content, prominent authors, as well as other specific data that can be accessed over the network 15 and associated with the system 120. Users of the system 120 and/or entities (including website administrators with the PYZ APP 132′ or PYZ WIDGET 132a′ embedded and running on their webpage(s)) with access to the system 120 will be able to perform wide data mining operations based on inputs from commenters, publishers and third party rating agencies or actors.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for placing displayable media on web pages, comprising:
providing an electronic document for placement over at least a portion of a hosted web page;
receiving displayable media input over a network from the first user whose browsing application is directed to the web page; and,
placing the displayable media input by the first user into the electronic document.

2. The method of claim 1, wherein the placing the displayable media includes placing the displayable media at a position in the electronic document corresponding to a user selected location on the underlying web page.

3. The method of claim 2, wherein the displayable media includes text defining a comment.

4. The method of claim 2, wherein the displayable media includes at least one of graphics, images, audio, video, defining a comment.

5. The method of claim 2, additionally comprising: providing content to the electronic document.

6. The method of claim 5, wherein the providing content includes providing content based on analyzing the displayable media of the electronic document.

7. The method of claim 6, wherein the providing content is additionally based on analyzing at least one of content from the web page, information about the history of the browsing application associated with a computer of the user, information about the user, and, input received from the user.

8. The method of claim 7, wherein the content includes at least one of activatable links to target web sites.

9. The method of claim 7, wherein the content includes information.

10. The method of claim 9, wherein the information includes advertising information.

11. The method of claim 1, wherein the providing an electronic document for placement over at least a portion of a hosted web page includes providing the electronic document for placement over at least a substantial portion of the hosted web page.

12. The method of claim 1, wherein the network includes the Internet.

13. A system for placing displayable media on web pages, comprising:
a processor; and,
a storage media in communication with the processor, the storage media for storing instructions executable by the processor, the instructions comprising:
providing an electronic document for positioning over at least a portion of a hosted web page;
receiving displayable media input over a network from the first user whose browsing application is directed to the web page; and,
placing the displayable media input by the first user into the electronic document.

14. The system of claim 13, wherein the instructions additionally comprise: placing the displayable media at a position in the electronic document corresponding to a user selected location on the underlying web page.

15. The system of claim 14, wherein the instructions additionally comprise: providing content to the electronic document.

16. The system of claim 15, wherein the providing content instructions include instructions for providing content based on analyzing the displayable media of the electronic document.

17. The system of claim 16, wherein the providing content instructions additionally include instructions for providing content based on analyzing at least one of content from the web page, information about the history of the browsing application associated with a computer of the first user, information about the user, and, input received from the first user.

18. A computer usable non-transitory storage medium having a computer program embodied thereon for causing a suitably programmed system to place displayable media on web pages, the web pages accessible via a network, by performing the following steps when such program is executed on the system, the steps comprising:
providing an electronic document for placement over at least a portion of a hosted web page;
receiving displayable media input over the network from the first user whose browsing application is directed to the web page; and,
placing the displayable media input by the first user into the electronic document.

19. The computer usable non-transitory storage medium of claim 18, wherein the step of placing the displayable media includes placing the displayable media at a position in the electronic document corresponding to a user selected location on the underlying web page.

20. The computer usable non-transitory storage medium of claim 19, wherein the displayable media includes text defining a comment.

21. The computer usable non-transitory storage medium of claim 20, wherein the displayable media includes at least one of graphics, images, audio, video, defining a comment.

22. The computer usable non-transitory storage medium of claim 21, additionally comprising the step of: providing content to the electronic document.

23. The computer usable non-transitory storage medium of claim 22, wherein the step of providing content includes providing content based on analyzing the displayable media of the electronic document.

24. The computer usable non-transitory storage medium of claim 23, wherein the step of providing content is additionally based on analyzing at least one of content from the web page, information about the history of the browsing application associated with a computer of the user, information about the user, and, input received from the user.

25. The computer usable non-transitory storage medium of claim 24, wherein the content includes at least one of activatable links to target web sites.

26. The computer usable non-transitory storage medium of claim 24, wherein the content includes information.

27. The computer usable non-transitory storage medium of claim 26, wherein the information includes advertising information.

28. The computer usable non-transitory storage medium of claim 18, wherein the step of providing an electronic document for placement over at least a portion of a hosted web page includes providing the electronic document for placement over at least a substantial portion of the hosted web page.

29. The computer usable non-transitory storage medium of claim 18, wherein the network includes the Internet.
